(19) United States
(12) Patent Application Publication
(10) Pub. No.: US 2014/0067544 A1
(43) Pub. Date: Mar. 6, 2014

(54) PROVIDING OFFER(S) TO USERS IN A SOCIAL NETWORKING SYSTEM BASED ON COMPATIBILITY OF THE USERS WITH THE OFFER(S)

(71) Applicants: Aaron J. Klish, St. Joseph, IL (US); Greg Muchnik, Champaign, IL (US); Matthew Ahrens, Champaign, IL (US)

(72) Inventors: Aaron J. Klish, St. Joseph, IL (US); Greg Muchnik, Champaign, IL (US); Matthew Ahrens, Champaign, IL (US)

(73) Assignee: YAHOO! INC., Sunnyvale, CA (US)

(21) Appl. No.: 13/597,059

(22) Filed: Aug. 28, 2012

(51) Int. Cl. G06Q 30/02

(52) U.S. Cl. 705/14.66

(57) ABSTRACT

Techniques are described herein for, among other things, providing relevant offers to group(s) of users in a social networking system. The offers may specify discounted prices (a.k.a. discounted offers) for good(s) and/or service(s). Each of the offers may be represented as a coupon, a gift certificate, etc. Users having at least one first attribute in common are assigned to a group. A measure of compatibility between the users in the group and each of a plurality of offers is determined. Each measure of compatibility may be determined by comparing at least one second attribute of the users in the group and at least one third attribute of the respective offer. The offer that has a highest measure of compatibility among the plurality of offers is deemed to be the most relevant offer for the group of users and is presented to the users (or a subset thereof) in the group.

### BACKGROUND OF THE INVENTION

1. Field of the Invention

The present invention generally relates to social networking. In particular, the present invention is related to providing offer(s) to users in a social networking system based on compatibility of the users with the offer(s).

2. Background

Social networking systems, including social networks, such as Facebook®, MySpace®, Twitter®, and LinkedIn®, enable a user to interact with other users who are members of an affinity set of the user. Such other users are often referred to as “connections” of the user. For example, an affinity set may be any group of persons, including a group of friends, business associates, players of a massively multiplayer online game, persons with a common interest, all users of a social network, application (“app”), or web site, or a subgroup thereof. A user may belong to any number of affinity sets.

For instance, a user may broadcast social networking updates (e.g., messages regarding the user, the user's observations, etc.) to the user's connections, and the user may receive social networking updates from those connections. The social networking updates may be provided via email, short message service (SMS), instant message (IM), or any other suitable messaging technology.

Social networking systems continue to be popular among users, as the number of users that have joined social networking systems continues to grow on a daily basis. Facebook® alone is reaching one billion users. Accordingly, advertisers are constantly searching for better ways to effectively promote products and/or services to these users.

### BRIEF SUMMARY OF THE INVENTION

Various approaches are described herein for, among other things, providing relevant offers to group(s) of users in a social networking system. The offers may specify discounted prices (a.k.a. discounted offers) for good(s) and/or service(s). Each of the offers may be represented as a coupon, a gift certificate, etc. Users having at least one first attribute in common are assigned to a group. A measure of compatibility between the users in the group and each of a plurality of offers is determined. Each measure of compatibility may be determined by comparing at least one second attribute of the users in the group and at least one third attribute of the respective offer. The offer that has a highest measure of compatibility among the plurality of offers is deemed to be the most relevant offer for the group of users and is presented to the users (or a subset thereof) in the group.

An example method is described in which groups of users of a social networking system are determined based on the users in each of the groups having respective first attribute(s) in common. Each of the groups includes multiple users. A measure of compatibility between the users in each group and each of a plurality of offers is determined by comparing second attribute(s) of each of the users in the respective group and third attribute(s) of the respective offer. Each offer specifies a price of commerce element(s). A commerce element is a good or a service. For each group, respective selected offer(s) are presented to at least a subset of the users in the group in response to the respective selected offer(s) having a highest measure of compatibility among the offers.

An example system is described that includes grouping logic, compatibility logic, and presentation logic. The grouping logic is configured to determine groups of users of a social networking system based on the users in each of the groups having respective first attribute(s) in common. Each of the groups includes multiple users. The compatibility logic is configured to, for each of the groups, determine a measure of compatibility between the users in the group and each of the offers by comparing second attribute(s) of each of the users in the group and third attribute(s) of the respective offer. Each of the offers specifies a price of commerce element(s). The presentation logic is configured to, for each of the groups, present selected offer(s) to at least a subset of the users in the group in response to the selected offer(s) having a highest measure of compatibility among the offers.

An example computer program product is described that includes a computer-readable medium having computer program logic recorded thereon for enabling a processor-based system to provide offers among groups of users based on compatibility between the groups and the offers. The computer program product includes a first program logic module, a second program logic module, and a third program logic module. The first program logic module is for enabling the processor-based system to determine groups of users of a social networking system based on the users in each of the groups having respective first attribute(s) in common. Each of the groups includes multiple users. The second program logic module is for enabling the processor-based system to, for each of the groups, determine a measure of compatibility between the users in the group and each of the offers by comparing second attribute(s) of each of the users in the group and third attribute(s) of the respective offer. Each of the offers specifies a price of commerce element(s). The third program logic module is for enabling the processor-based system to, for each of the groups, present selected offer(s) to at least a subset of the users in the group in response to the selected offer(s) having a highest measure of compatibility among the offers.

Further features and advantages of the disclosed technologies, as well as the structure and operation of various embodiments, are described in detail below with reference to the accompanying drawings. It is noted that the invention is not limited to the specific embodiments described herein. Such embodiments are presented herein for illustrative purposes only. Additional embodiments will be apparent to persons skilled in the relevant art(s) based on the teachings contained herein.

### BRIEF DESCRIPTION OF THE DRAWINGS/FIGURES

The accompanying drawings, which are incorporated herein and form part of the specification, illustrate embodiments of the present invention and, together with the description, further serve to explain the principles involved and to enable a person skilled in the relevant art(s) to make and use the disclosed technologies.

FIG. 1 is a block diagram of an example offer system in accordance with an embodiment described herein.

FIG. 2 depicts a flowchart of an example method for providing offers among groups of users based on compatibility between the groups and the offers in accordance with an embodiment described herein.

FIG. 3 depicts a flowchart of an example method for determining groups of users in a social networking system in accordance with an embodiment described herein.

FIG. 4 depicts a distributed hash table in accordance with an embodiment described herein.

FIG. 5 depicts a flowchart of an example method for determining a measure of compatibility between a subset of users in a group and each of a plurality of offers and presenting the offer having a highest measure of compatibility to the subset of users in accordance with an embodiment described herein.

FIG. 6 depicts a flowchart of an example method for determining one or more subsets of users from a plurality of users in a group in accordance with an embodiment described herein.

FIG. 7 depicts groups of users that are represented by respective directed graphs in accordance with an embodiment described herein.

FIG. 8 depicts a flowchart of an example method for presenting at least one selected offer to specified users in accordance with an embodiment described herein.

FIGS. 9, 10, 11, and 12 are illustrations of example graphical user interfaces (GUIs) of a calendar application in accordance with embodiments described herein.

FIG. 13 is a block diagram of an example implementation of an automated offer system shown in FIG. 1 in accordance with an embodiment described herein.

FIG. 14 is a block diagram of a computer in which embodiments may be implemented.

The features and advantages of the disclosed technologies will become more apparent from the detailed description set forth below when taken in conjunction with the drawings, in which like reference characters identify corresponding elements throughout. In the drawings, like reference numbers generally indicate identical, functionally similar, and/or structurally similar elements. The drawing in which an element first appears is indicated by the leftmost digit(s) in the corresponding reference number.

### DETAILED DESCRIPTION OF THE INVENTION

### I. Introduction

The following detailed description refers to the accompanying drawings that illustrate exemplary embodiments of the present invention. However, the scope of the present invention is not limited to these embodiments, but is instead defined by the appended claims. Thus, embodiments beyond those shown in the accompanying drawings, such as modified versions of the illustrated embodiments, may nevertheless be encompassed by the present invention.

References in the specification to “one embodiment,” “an embodiment,” “an example embodiment,” or the like, indicate that the embodiment described may include a particular feature, structure, or characteristic, but every embodiment may not necessarily include the particular feature, structure, or characteristic. Moreover, such phrases are not necessarily referring to the same embodiment. Furthermore, when a particular feature, structure, or characteristic is described in connection with an embodiment, it is submitted that it is within the knowledge of one skilled in the art to implement such feature, structure, or characteristic in connection with other embodiments whether or not explicitly described.

In general, terminology may be understood at least in part from usage in context. For example, terms, such as “and”, “or”, or “and/or,” as used herein may include a variety of meanings that may depend at least in part upon the context in which such terms are used. Typically, “or” if used to associate a list, such as A, B or C, is intended to mean A, B, and C, here used in the inclusive sense, as well as A, B or C, here used in the exclusive sense. In addition, the term “one or more” as used herein, depending at least in part upon context, may be used to describe any feature, structure, or characteristic in a singular sense or may be used to describe combinations of features, structures or characteristics in a plural sense. Similarly, terms, such as “a,” “an,” or “the,” again, may be understood to convey a singular usage or to convey a plural usage, depending at least in part upon context. In addition, the term “based on” may be understood as not necessarily intended to convey an exclusive set of factors and may, instead, allow for existence of additional factors not necessarily expressly described, again, depending at least in part on context.

Example embodiments are capable of providing relevant offers to group(s) of users in a social networking system. The offers may specify discounted prices (a.k.a. discounted offers) for good(s) and/or service(s). Each of the offers may be represented as a coupon, a gift certificate, etc. Users having at least one first attribute in common are assigned to a group. A measure of compatibility between the users in the group and each of a plurality of offers is determined. Each measure of compatibility may be determined by comparing at least one second attribute of the users in the group and at least one third attribute of the respective offer. The offer that has a highest measure of compatibility among the plurality of offers is deemed to be the most relevant offer for the group of users and is presented to the users (or a subset thereof) in the group.

Techniques described herein have a variety of benefits as compared to conventional techniques for providing offers to users. For instance, the techniques described herein are capable of providing offers to groups of users (e.g., friends, family, co-workers, etc.) by automatically targeting groups based on shared interests, shared proximity, and/or shared availability. One benefit in doing so is that users no longer have to manually contact other users to determine if or when the other users are available to participate in an activity, or whether the other users are interested in participating in a particular activity.

Not only may such a technique enable groups of users to discover businesses and events relevant to the groups, but it may also enable businesses to target groups more effectively. Moreover, such a technique may encourage users to provide additional details about activities that they might enjoy for any given time frame, thereby allowing advertising companies to gain additional insights about these users.

### II. Example Embodiments

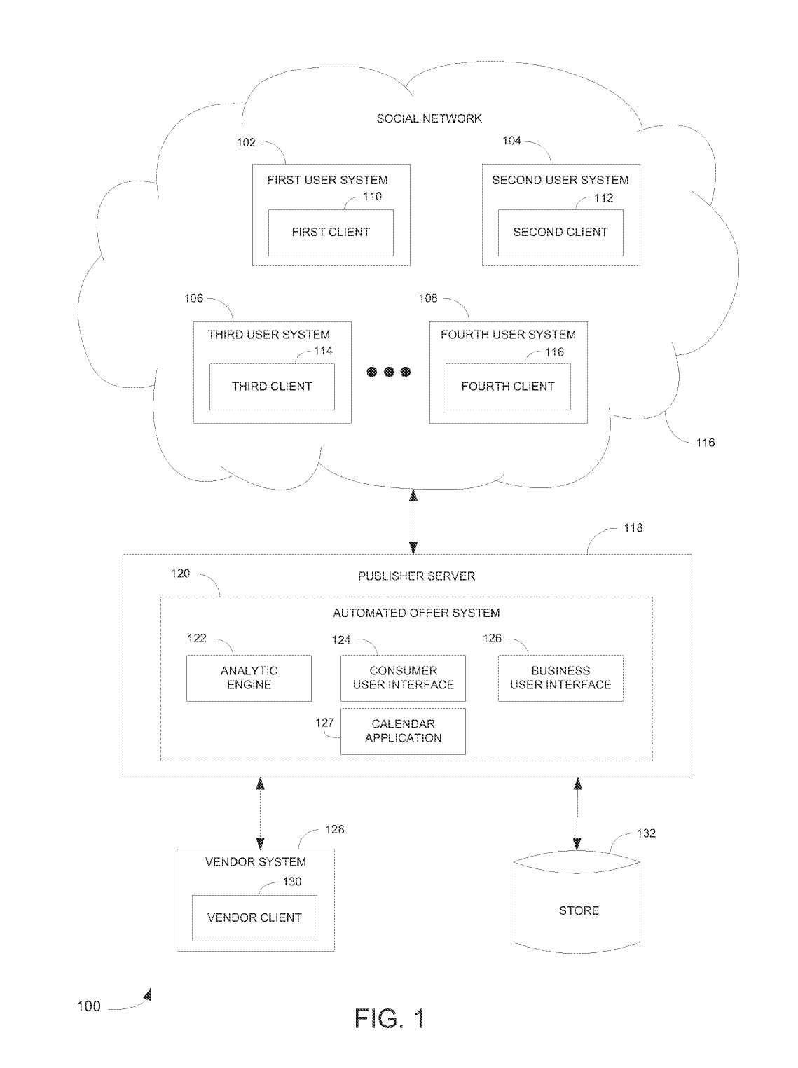

FIG. 1 shows a block diagram of an example offer system 100 in accordance with an embodiment described herein. Generally speaking, offer system 100 operates to provide relevant offers to group(s) of users in a social networking system. As shown in FIG. 1, offer system 100 includes a social networking system (e.g., social network 116) that includes a plurality of users systems 102, 104, 106, and 108; a publisher server 118; a vendor system 128; and a store 132. Communication among, user systems 102, 104, 106, and 108, publisher server 118, vendor system 128, and store 132 is carried out over a network using well-known network communication protocols. The network may be a wide-area network (e.g., the Internet), a local area network (LAN), another type of network, or a combination thereof.

Social network 116 is an online social network or a combination of social networks, that includes a community of users (network participating persons) who interact within social network 116 using respective user systems 102, 104, 106, and 108. Each of the user systems 102, 104, 106, and 108 is a computer, a personal digital assistant (PDA), or other processing system, including one or more processors, which is configured to enable a user to provide social networking updates to other users in social network 116. For instance, each of the user systems 102, 104, 106, and 108 includes a respective client 110, 112, 114, 116 (e.g., a Web browser), which enables a respective user to provide such updates.

Although four user systems 102, 104, 106, and 108 are depicted in FIG. 1 for illustrative purposes, persons skilled in the relevant art(s) will recognize that social network 116 may include any number of user systems (including hundreds, thousands, or even millions of user systems). Social network 116 operates within a communication network, such as a local area network (LAN), a wide area network (WAN) (e.g., the Internet), another type of network, or a combination thereof. For example, social network 116 may be based in the World Wide Web. The communication network enables communication between user systems 102, 104, 106, and 108. Social network 116 may enable one or more ways for users to interact, including enabling communications between user systems 102, 104, 106, and 108 through blogging, discussion groups, email, file sharing, instant messaging, online chat, tweeting, video, voice chat, and/or other user communication mechanisms.

User systems 102, 104, 106, and 108 are also capable of communicating with publisher server 118. For example, user systems 102, 104, 106, and 108 may use their respective clients 110, 112, 114, and 116 to access sites (e.g., Web sites) that are hosted by publisher server 118. Although four user systems 102, 104, 106, and 108 and one publisher server 118 are depicted in FIG. 1, persons skilled in the relevant art(s) will recognize that any number of user systems may be communicatively coupled among any number of publisher servers.

Publisher server 118 is a computer or other processing system, which includes one or more processors, that is capable of communicating with user systems 102, 104, 106, and 108. Examples of a publisher server include but are not limited to a dedicated rack-mounted server, a desktop computer, a laptop computer, a set top box, etc. Publisher server 118 is configured to host a site (e.g., a Web site) published by a corresponding publisher so that such a site is accessible to users of offer system 100 via user systems 102, 104, 106, and 108.

Publisher server 118 is further configured to execute software programs that provide information to users in response to receiving requests, such as hypertext transfer protocol (HTTP) requests, from users, instant messaging (IM) applications, or web-based email. For example, the information may include web pages, images, other types of files, output of executables residing on the publisher servers, IM chat sessions, emails, coupons, gift certificates, advertisements, etc. In accordance with this example, the software programs that are executing on publisher server 118 may provide web pages and/or emails that include interface elements (e.g., buttons, widgets, hyperlinks, etc.) that a user may select for accessing the other types of information. The web pages may be provided as hypertext markup language (HTML) documents and objects (e.g., files) that are linked therein, for example. In accordance with an embodiment, the web pages are provided as dynamic web pages, which may be generated in various ways, including being generated with client-side scripting languages (e.g., JavaScript®).

Publisher server 118 is shown to include an automated offer system 120. Automated offer system 120 is configured to provide relevant offers to group(s) of users in social network 116. Automated offer system 120 includes an analytic engine 122, a consumer user interface 124, a business user interface 126, and a calendar application 127. Analytic engine 122 is configured to determine first attribute(s) of each of the users of social network 116. Analytic engine 122 is further configured to assign users having common first attribute(s) to a respective group. In one example embodiment, first attribute(s) of a user include a period of time in which the user is available to participate in an activity (e.g., attend an event, dine at a restaurant, etc.). Analytic engine 122 may be configured to determine first attribute(s) of a user by mining data from a calendar application (e.g., calendar application 127) associated with the user. The data mined may indicate which months, days and/or times a user is available to participate an activity (i.e., a period of time in which the user currently has no appointment scheduled).

In one example embodiment, analytic engine 122 is further configured to determine subsets of users within each group. Each subset of users includes users that have formed a social connection with other user(s) in the subset. In one aspect of this embodiment, analytic engine 122 determines the subsets of users within each group by creating a directed graph that includes a plurality of nodes and directed link(s). Each node corresponds to a respective user in the group, and each of the directed links connects one node to another node to indicate a social connection between the respective corresponding users in the group. Once the directed graph is created, analytic engine 122 analyzes the directed graph to determine whether a predetermined type of relationship is formed among the plurality of nodes.

In one example embodiment, the predetermined type of relationship is specified by a user seeking to perform an event with other users. In another example embodiment, the predetermined type of relationship is specified by a vendor seeking to provide an offer to users having a designated type of relationship. In yet another example embodiment, automated offer system 120 is configured to specify a default type of relationship in response to a user or a vendor not specifying the predetermined type of relationship.

In the event that analytic engine 122 determines that a predetermined type of relationship is formed, the users that correspond to the nodes that form the predetermined type of relationship are designated to define a subset of users from the group.

Analytic engine 122 is further configured to determine a measure of compatibility between users in a group (or a subset thereof) and a plurality of offers. Analytic engine 122 determines the measure of compatibility by comparing second attribute(s) of users in a respective group (or a subset thereof) and third attribute(s) of the plurality of offers. Once the measures of compatibility are determined, analytic engine 122 determines the offer having the highest measure of compatibility among the plurality of offers and presents the offer to the users (or a subset thereof) in the group.

In one example embodiment, the offer is presented to each user in the group (or a subset thereof) via a respective calendar application (e.g., calendar application 127). Calendar application 127 may be a Web-based application hosted by publisher server 118. Calendar application 127 may provide at least an electronic version of a calendar that displays dates, days of the week, and times for each of the days (and any appointments scheduled thereon), an address book including a list of contacts for a respective user of calendar application 127, etc. An offer may be presented as an appointment on the electronic calendar that is provided by calendar application 127. Although calendar application 127 is depicted in FIG. 1 as being executed on publisher server 118, persons skilled in the relevant art(s) will recognize that a calendar application (or client-side aspects thereof) may be executed on each of user systems 102, 104, 106, and 108.

Analytic engine 122 may perform the grouping and measure of compatibility analysis and present offers to users in response to receiving a request from a user, though the scope of the example embodiments is not limited in this respect. In one example embodiment, a user creates an appointment using calendar application 127 to generate the request. For example, the user may indicate a time and date in which he or she is available to participate in an activity using calendar application 127, and in response, analytic engine 122 may perform the grouping and measure of compatibility analysis and present offers to users accordingly. In another example embodiment, analytic engine 122 automatically performs the grouping and measure of compatibility analysis on a periodic basis and automatically populate a calendar application 127 for respective users with offers.

Consumer user interface 124 is configured to allow users to specify their respective second attributes. For example, consumer user interface 124 may include selectable interface elements (e.g., via a graphical user interface (GUI)) that correspond to respective second attributes. In accordance with this example, selection of an interface element may indicate that the corresponding second attribute is specified. A second attribute for a particular user may indicate at least a geographic region associated with the user, interest(s) of the user, and/or preference(s) of the user. The geographic region associated with the user may be a present location of the user, a location at which the user will be on a future date, etc. Users may access consumer user interface 124 using their respective clients 110, 112, 114, and 116 executing on their respective user systems 102, 104, 106, and 108.

An interest of the user may specify the type of activity in which the user is interested (e.g., breakfast, lunch, dinner, food, tomorrow, weekend, movie, golf, tennis, happy hour, birthday party, volunteer, study session, girls' night out, museum tour, cruise, shopping, vacation, business strategy meeting, etc.) and/or the type of venue at which the user is interested in performing the activity (e.g., a restaurant, a golf course, a bar, a hotel, a library, a museum, a retail store, a mall, a ship, a country, a state, a city, another geographical region, etc.). Interests regarding the venue may be dependent on the type of venue. For example, interests regarding a restaurant venue may include steak, burger, ice cream, five star, business casual, casual, sea food, Chinese, gourmet, outdoor seating, or any other suitable interest.

Examples of a preference include, but are not limited to an indication of other users with whom the user is interested in participating in a specified activity (i.e., a white list of users), an indication of other users with whom the user is not interested in participating in a specified activity (i.e., a black list of users), an indication of a number of users that the user is interested in participating in a specified activity, an indication of an amount that the user is willing to pay for a specified activity, and/or an indication of a distance that the user is willing to travel to participate in a specified activity. In one embodiment, the white list of users is prioritized to indicate which of the specified users on the white list with whom the user would most like to participate in an activity. In another embodiment, the first attribute (i.e., a period of time in which the user is available to attend an event) is specified by the user via consumer user interface 124 (as opposed to being mined from calendar application 127). In one embodiment, consumer user interface 124 may be integrated with calendar application 127 (as opposed to being integrated with a Web site that provides instances of the offer).

In one example embodiment, a geographic region associated with a user, interest(s) of a user, and/or preference(s) of a user is inferred (as opposed to being explicitly specified by the user via consumer user interface 124). For example, a geographic region associated with a user may be determined from information associated with calendar application 127. For instance, a user may create appointment(s) using calendar application 127. The appointments may indicate the location of the appointment. Analytic engine 122 may retrieve this information from calendar application to infer the location of the user.

In another example, analytic engine 122 may infer the geographic region associated with a user from sources of data in addition to or in lieu of calendar application 127. For instance, analytic engine 122 may infer a geographic region associated with a user by using location data provided by a device (e.g., a mobile device) associated with the user. Such location data includes but is not limited to cell tower data, general packet radio service (GPRS) data, global positioning service (GPS) data, wireless fidelity (WI-FI) data, personal area network data, internet protocol (IP) address data and/or data from other network access points.

In yet another example, the interest(s) and the preference(s) of a user may be inferred by analyzing data associated with interactions carried out by a user via social network 114. Examples of such interactions include but are not limited to blogging, emailing, instant messaging, online chatting, and/or the like.

Business user interface 126 is configured to allow vendors to specify their respective third attributes. A third attribute of a vendor may indicate at least a location of an activity offered by the vendor (e.g., street name, city, state, zip code, address, and/or the like), a description of an activity offered by the vendor (e.g., sporting event, concert, restaurant, type of restaurant and/or the like), a time and/or a date on which an activity provided by the vendor is made available (e.g., the operating times of the business and/or a specified time and/or date that the vendor will honor the offer), and/or information indicative of the type(s) of users the vendor would like to target. In one embodiment, users are classified based on age, gender, location, and/or the like. For instance, a first subset of the users may be assigned to a first class that corresponds to a first age (or range of ages); a second subset of the users may be assigned to a second class that corresponds to a second age (or range of ages), and so on. In another embodiment, each user is classified based on a type of relationship that the respective user forms with other users.

Vendor system 128 is a computer or other processing system, including one or more processors. Vendor system 128 may provide offer(s) that the vendor would like to present to a group of users to publisher server 118. Vendor system 128 may also provide third attribute(s) associated with the offer(s) via business user interface 126. A vendor may access business user interface 126 using vender client 130 (e.g., a Web browser) executing on vendor system 128. Vendor system 128 may also provide additional information such as bidding information that indicates an amount that the vendor is willing to pay to recommend the activity being offered by the vendor to a group of users via business user interface 126.

Although one vendor system 128 is depicted in FIG. 1, persons skilled in the relevant art(s) will recognize that any number of vendor systems may be communicatively coupled to publisher server 118 (or any number of other publisher servers that are not shown).

Store 132 is configured to store the first and second attributes associated with the users of social network 116 and the third attributes of the plurality of offers specified by the vendors. Analytic engine 122 may retrieve and store the first attributes of each of the users of social network 116 from calendar application 127 on a periodic basis. For instance, the first attributes may be retrieved and stored once every 24 hours, once every 12 hours, once per hour, once per week, or other suitable period of time. Analytic engine 122 may store the second attributes associated with the users in store 132 once the users have specified the second attributes using consumer user interface 124. Analytic engine 122 may store the third attributes associated with the offer in store 132 once the vendors have specified the third attributes using business user interface 126.

Store 120 may be any suitable type of store. One type of store is a database. For instance, store 120 may be a relational database, an entity-relationship database, an object database, an object relational database, an extensible markup language (XML) database, etc. In one example embodiment, store 132 is configured as a persistence layer (e.g., by using a database management system). Although one store 132 is depicted in FIG. 1, persons skilled in the relevant art(s) will recognize that any number stores may be used to store the first attributes, the second attributes and the third attributes. In addition, although store 132 is depicted in FIG. 1 as not being part of automated offer system 120, persons skilled in the relevant art(s) will recognize that store 132 may be included in automated offer system 120 (e.g., as part of analytic engine 122).

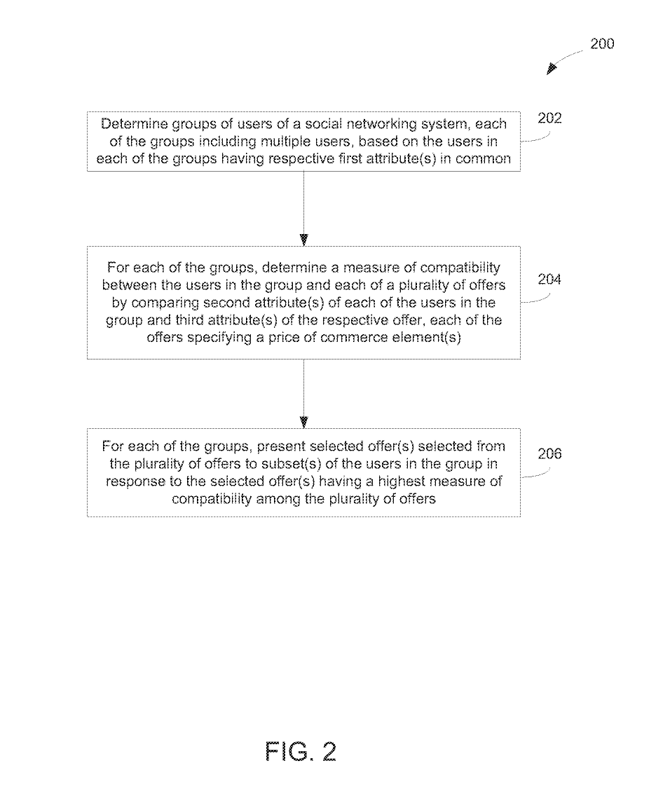

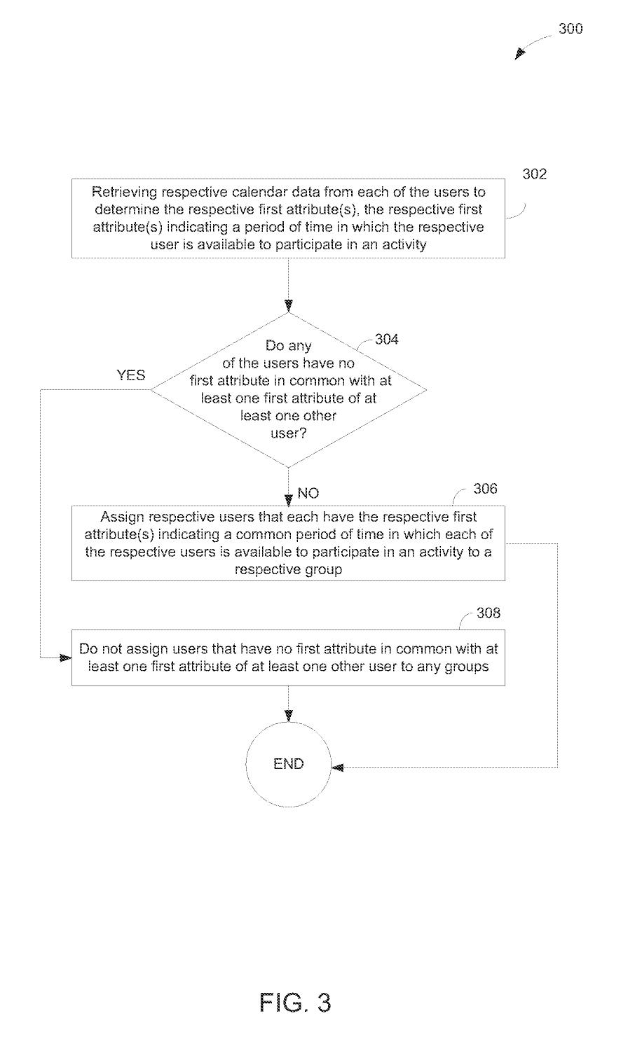

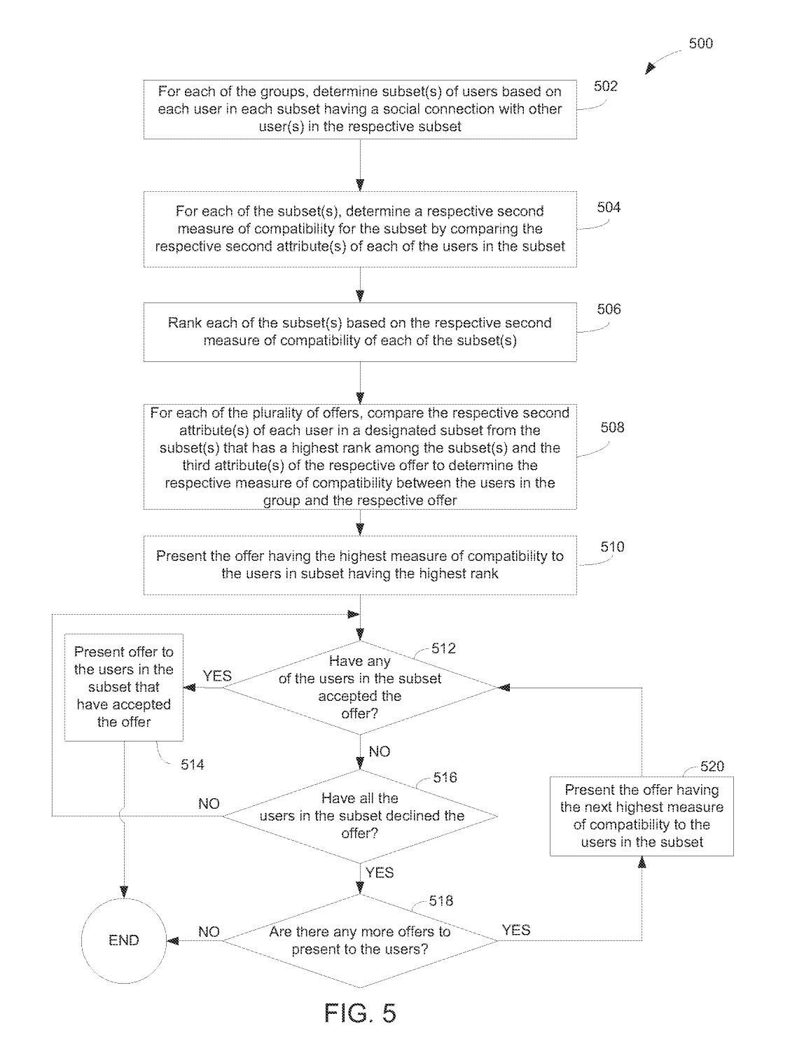

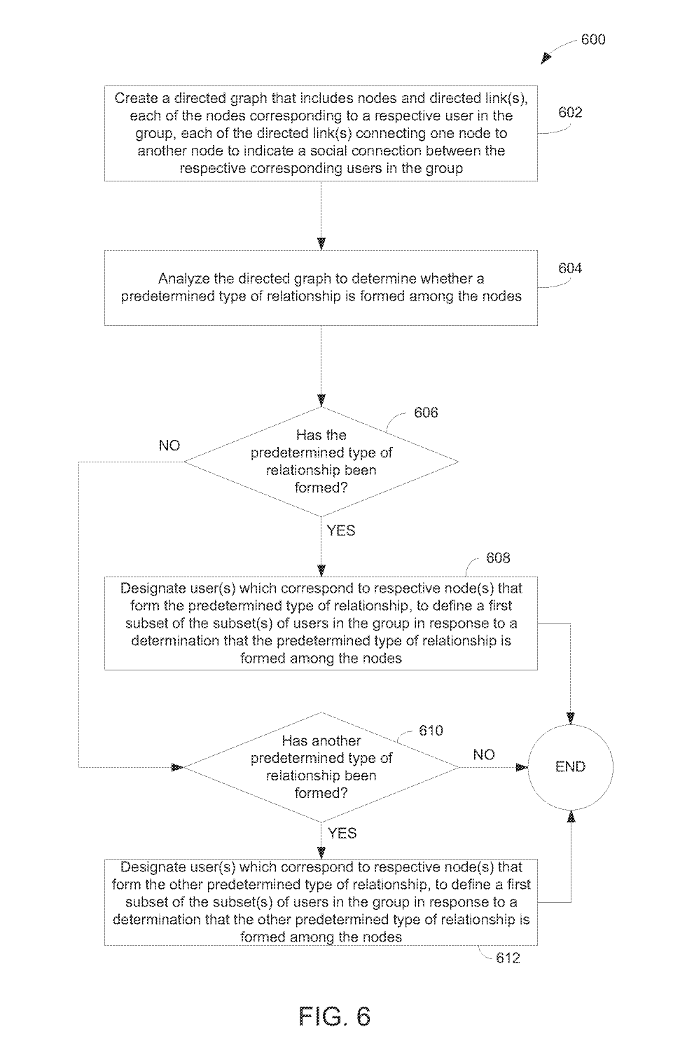

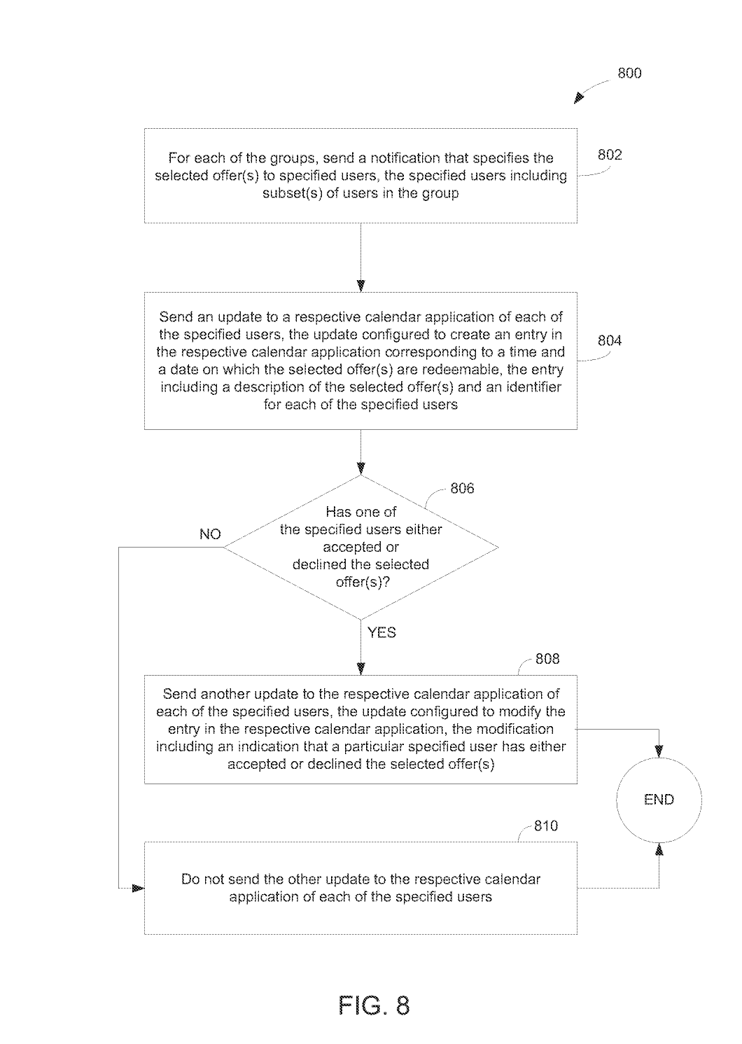

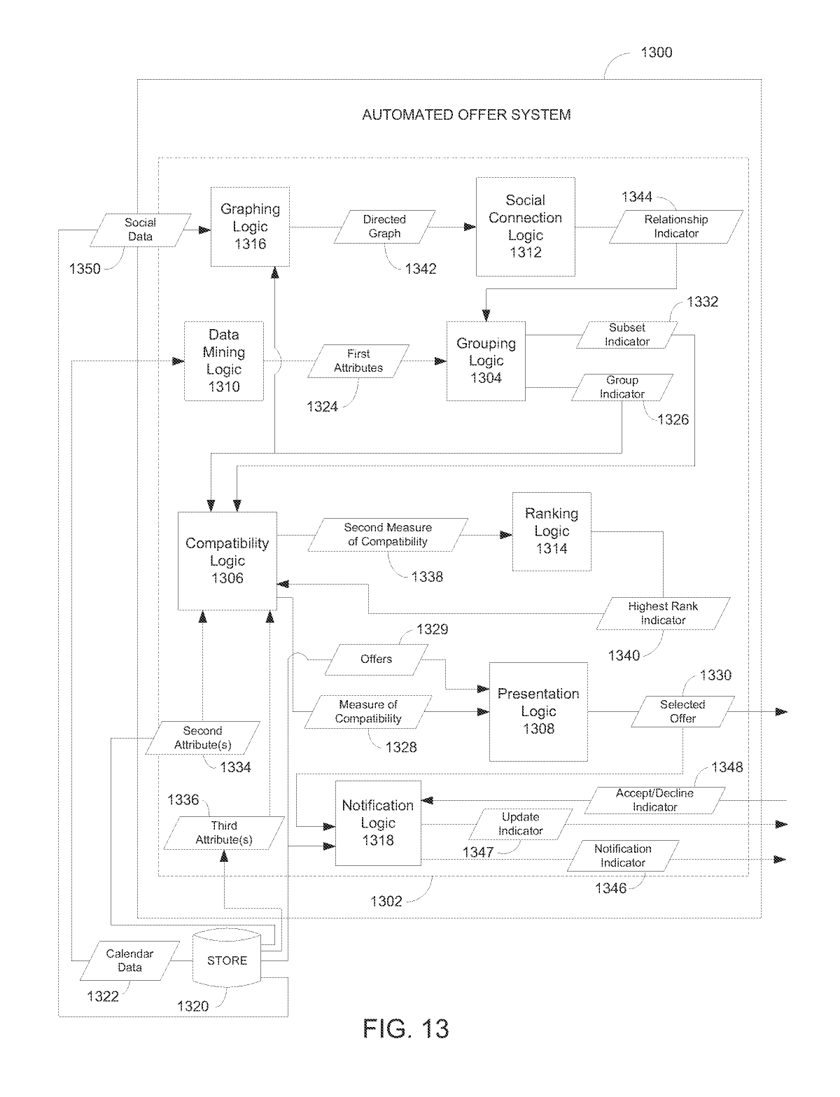

FIG. 2 depicts a flowchart 200 of an example method for providing offers among groups of users based on compatibility between the groups and the offers in accordance with an embodiment described herein. FIG. 3 depicts a flowchart 300 of an example method for determining the groups of users in a social networking system (e.g., social network 116) in accordance with an embodiment described herein. FIG. 5 depicts a flowchart 500 of an example method for determining a measure of compatibility between a subset of users in the group and each of a plurality of offers and presenting the offer having the highest measure of compatibility to the subset of users in accordance with an embodiment described herein. FIG. 6 depicts a flowchart 600 of an example method for determining the subset(s) of users from the plurality of users in the group in accordance with an embodiment described herein. FIG. 8 depicts a flowchart 800 of an example method for presenting at least one selected offer to specified users in accordance with an embodiment described herein. Flowcharts 200, 300, 500, 600, and 800 may be performed by analytic engine 122 of FIG. 1, for example. For illustrative purposes, flowcharts 200, 300, 500, 600, and 800 are described with respect to analytic engine 1302 of automated offer system 1300 shown in FIG. 13, which is an example of analytic engine 122 according to an embodiment. As shown in FIG. 13, analytic engine 1302 includes grouping logic 1304, compatibility logic 1306, presentation logic 1308, data mining logic 1310, social connection logic 1312, ranking logic 1314, graphing logic 1316, and notification logic 1318. FIG. 13 also includes a store 1320, which is an example of store 132 depicted in FIG. 1 according to an embodiment. Further structural and operational embodiments will be apparent to persons skilled in the relevant art(s) based on the discussion regarding flowcharts 200, 300, 500, 600, and 800.

As shown in FIG. 2, the method of flowchart 200 begins at step 202. In step 202, groups of users of a social networking system (e.g., social network 116) are determined based on the users in each of the groups having respective first attribute(s) in common. Each group includes multiple users.

In an example embodiment, the respective first attribute(s) are periods of time in which the user is available to participate in an activity (e.g., attend an event, dine at a restaurant, etc.). In accordance with this embodiment, users having the same period(s) of time in which they are available to participate in an activity are grouped together. In an example implementation, grouping logic 1304 determines groups of users of a social networking system based on the users in each of the groups having respective first attribute(s) 1324 in common to provide group indicator 1326 to compatibility logic 1306. Group indicator 1326 indicates which users are in each group. In an aspect of this implementation, group indicator 1326 is stored in store 1320, and compatibility logic 1306 retrieves group indicator 1326 as needed.

At step 204, for each of the groups, a measure of compatibility between the users in the group and each of a plurality of offers is determined by comparing second attribute(s) of each of the users in the group and third attribute(s) of the respective offer. Each offer specifies a price of commerce element(s). A commerce element is a good or a service.

For example, suppose a group of users includes User A, User B, and User C. User A has second attributes of: “steak,” “dinner”, and “business casual”. User B has second attributes of “steak,” “dinner,” and “five star”. User C has second attributes of “sea food,” “dinner,” and “business casual”.

Further suppose that three offers are available. The first offer has third attributes of “steak,” “dinner,” five star”. The second offer has third attributes “Mexican,” “dinner,” and “business casual.” The third offer has third attributes of “pancakes,” “breakfast,” and “casual.” The third attributes of each of the three offers are compared to the second attributes of the users to determine a measure of compatibility between each offer and the users of the group. Each match between a third attribute of an offer and a second attribute of a user may count toward the measure of compatibility. For instance, when comparing the “steak” attribute of the first offer to the second attributes of the users, the “steak” attribute matches two times (one time with User A, and another time with User B). When comparing the “dinner” attribute of the first offer to the second attributes of the users, the “dinner” attribute matches three times (one time with each of User A, User B, and User C). When comparing the “five star” attribute of the first offer to the second attributes of the users, the “five star” attribute matches one time (with User B). The number of times each of the third attributes of the first offer matches with a second attribute of any of the users is added to determine a measure of compatibility for the first offer. Thus, in this example, the measure of compatibility for the first offer is 6.

When comparing the “Mexican” attribute of the second offer to the second attributes of the users, the “Mexican” attribute matches zero times (i.e., none of the users have the “Mexican” attribute). When comparing the “dinner” attribute of the second offer to the second attributes of the users, the “dinner” attribute matches three times (one time with each of User A, User B, and User C). When comparing the “business casual” attribute of the second offer to the second attributes of the users, the “business casual” attribute matches two times (one time with each of User A and User C). The number of times each of the third attributes of the second offer matches with a second attribute of any of the users is added to determine a measure of compatibility for the second offer. Thus, in this example, the measure of compatibility for the second offer is 5.

When comparing the “pancakes” attribute of the third offer to the second attributes of the users, the “pancakes” attribute matches zero times (i.e., none of the users have the “pancakes” attribute). When comparing the “breakfast” attribute of the third offer to the second attributes of the users, the “breakfast” attribute matches zero times (i.e., none of the users have the “breakfast” attribute). When comparing the “casual” attribute of the third offer to the second attributes of the users, the “casual” attribute matches zero times (i.e., none of the users have the “casual”). The number of times each of the third attributes of the third offer matches with a second attribute of any of the users is added to determine a measure of compatibility for the third offer. Thus, in this example, the measure of compatibility for the third offer is 0.

The measure of compatibility determination described above with respect to the second and third attributes is one example technique and is not intended to be limiting. Other techniques for determining a measure of compatibility are within the scope of the example embodiments.

In one example embodiment, weights are assigned to second attributes. Each weight assigned to a second attribute represents the amount the second attribute contributes toward the measure of compatibility upon matching to a third attribute. A second attribute that is assigned a higher weight than another second attribute contributes toward the measure of compatibility more than the other second attribute. For example, a second attribute assigned a weight of 5 that matches a third attribute will contribute toward the measure of compatibility more than a second attribute assigned a weight of 1 that matches a third attribute.

In another example embodiment, the matches between second attributes and third attributes need not necessarily be exact matches. In this example embodiment, a second attribute and a third attribute are deemed a match if a measure of similarity between the second and third attribute reaches (e.g., is greater than or equal to) a threshold. However, if a measure of similarity between the second and third attribute does not reach the threshold, the second attribute and the third attribute may be deemed not a match. The measure of similarity between second and third attributes may be determined using various techniques known in the art. Such techniques include, but are not limited to, dictionary-based methods (e.g., WordNet-based semantic similarity techniques) and/or corpus-based methods (e.g., latent semantic analysis (LSA), pointwise mutual information and information retrieval (PMI-IR), and/or the like).

In an example implementation, compatibility logic 1306 determines measure of compatibility 1328 between the users in the group and each of the plurality of offers by comparing second attribute(s) 1334 of each of the users and third attribute(s) 1336 of the respective offer. The users in the group are indicated by group indicator 1326, which compatibility logic 1306 receives from grouping logic 1304. Compatibility logic 1306 retrieves second attribute(s) 1334 and third attribute(s) 1336 from store 1320. Compatibility logic 1306 provides measure of compatibility 1328 to presentation logic 1308.

At step 206, for each of the groups, selected offer(s) from the plurality of offers are presented to at least a subset of the users in the group in response to the selected offer(s) having a highest measure of compatibility among the plurality of offers.

For instance, using the example above, the first offer has the highest measure of compatibility among the three offers. In accordance with this example, the first offer is presented to the subset(s) of the users in the group. A subset may include at least one user in the group and may include up to all the users in the group.

In an example implementation, presentation logic 1308 presents the selected offer(s) 1330 to the subset(s) of users based on the measure of compatibility 1328 in accordance with any of the example embodiments discussed above. Presentation logic 1308 retrieves offers 1329 from store 1320.

In one example embodiment, if more than one offer has the highest measure of compatibility among the offers, then all such offers are presented to the subset(s) of the users in the group. In another example embodiment, only one of these offers is presented. In accordance with this embodiment, the offers are sorted (e.g., alphabetically, based on the price of the offers, etc.) into a list, and the first offer in the sorted list is presented to the subset(s) of the users in the group. In yet another example embodiment, all offers having a measure of compatibility greater than or equal to a specified threshold are presented to the user.

In some example embodiments, one or more steps 202, 204, and/or 206 of flowchart 200 may not be performed. Moreover, steps in addition to or in lieu of steps 202, 204, and/or 206 may be performed.

FIG. 3 depicts a flowchart 300 of an example method for determining the groups of users in a social networking system (e.g., social network 116) in accordance with an embodiment described herein. As shown in FIG. 3, the method of flowchart 300 begins at step 302. In step 302, respective calendar data for each of the users of social network 116 is retrieved to determine respective first attribute(s). The respective first attribute(s) indicate a period of time in which a respective user is available to participate in an activity (e.g., attend an event, dine at a restaurant, etc.). In an example implementation, data mining logic 1310 retrieves the respective calendar data 1322 for each of the users. For example, data mining logic 1310 may retrieve calendar data 1322 from store 1320. In another example, data mining logic 1310 may retrieve calendar data for each user directly from a respective calendar application (e.g., via an application programming interface (API)). Data mining logic 1310 provides the respective first attribute(s) 1324 determined from calendar data 1322 to grouping logic 1304.

At step 304, a determination is made whether any of the users (e.g., any users of social network 116) have no first attribute in common with at least one first attribute of at least one other user. For example, one user may have different periods of time of availability than any other user. If any users have a respective first attribute that is not in common with a respective first attribute of at least one user, flow continues to 308. Otherwise, flow continues to step 306. In an example implementation, grouping logic 1304 determines whether any users have a respective first attribute 1324 that is not in common with a respective first attribute 1324 of at least one user.

At step 306, respective users that each have the respective first attribute(s) indicating a common period of time in which each of the respective users is available to participate in an activity are assigned to a respective group. In an example implementation, grouping logic 1304 assigns the respective users that each have respective first attribute(s) 1324 indicating a common period of time in which each of the respective users is available to participate in an activity to a respective group. Grouping logic 1304 provides group indicator 1326, which indicates the groups to which each user has been assigned, to compatibility logic 1306. In one example embodiment, group indicator 1326 is stored in store 1320, and compatibility logic 1306 retrieves group indicator 1326 as needed.

At step 308, users that have no first attribute in common with at least one first attribute of at least one other user are not assigned to any groups. In an example implementation, grouping logic 1304 does not assign

In some example embodiments, one or more steps 302, 304, 306, and/or 308 of flowchart 300 may not be performed. Moreover, steps in addition to or in lieu of steps 302, 304, 306, and/or 308 may be performed.

In an example embodiment, the groups of users are organized as a distributed hash table, which stores key/value pairs. Each key represents a period of time, and the value(s) associated with each key represent the users who are available to participate in an activity at the period of time represented by the key.

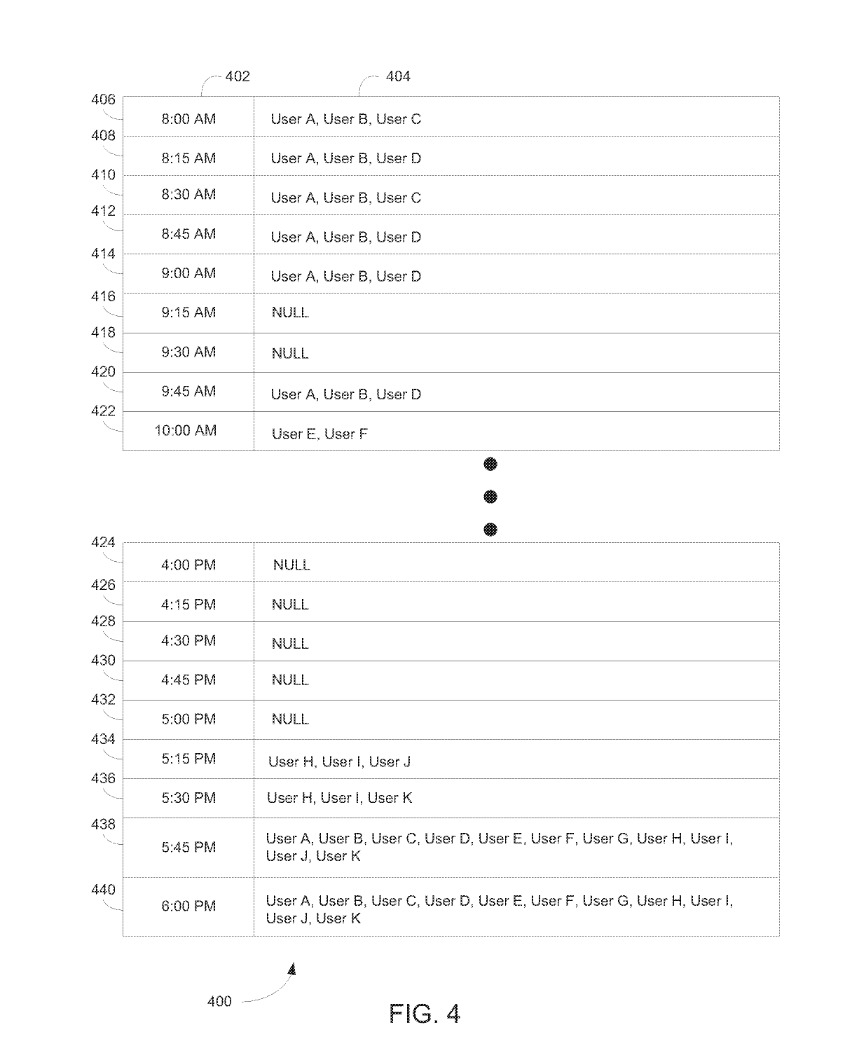

FIG. 4 depicts a distributed hash table 400 in accordance with an embodiment described herein. As shown, distributed hash table 400 includes two columns 402 and 404 for illustrative purposes and is not intended to be limiting. Column 402 stores the keys of hash table 400. Each key represents a respective period of time. In the example embodiment shown in FIG. 4, each period of time has a duration of 15 minutes for illustrative purposes, though it will be recognized that each period of time may have any suitable duration. Column 404 stores the values associated with each of the keys. The values associated with each key represent the users that are available during the period of time represented by each key. Using a distributed hash table in such a manner may advantageously ensure that the users associated with any given period of time can be retrieved quickly and efficiently.

Row 406 indicates that User A, User B, and User C are available to participate in an activity at 8:00 AM. Row 408 indicates that User A, User B, and User D are available to participate in an activity at 8:15 AM. Row 410 indicates that User A, User B, and User C are available to participate in an activity at 8:30 AM. Row 412 indicates that User A, User B, and User D are available to participate in an activity at 8:45 AM. Row 414 indicates that User A, User B, and User D are available to participate in an activity at 9:00 AM. Row 416 indicates that no users are available to participate in an activity at 9:15 AM. Row 418 indicates that no users are available to participate in an activity at 9:30 AM. Row 420 indicates that User A, User B, and User D are available to participate in an activity at 9:45 AM. Row 422 indicates that User E and User F are available to participate in an activity at 10:00 AM. Row 424 indicates that no users are available to participate in an activity at 4:00 PM. Row 426 indicates that no users are available to participate in an activity at 4:15 PM. Row 428 indicates that no users are available to participate in an activity at 4:30 PM. Row 430 indicates that no users are available to participate in an activity at 4:45 PM. Row 432 indicates that no users are available to participate in an activity at 5:00 PM. Row 434 indicates that User H, User I, and User J are available to participate in an activity at 5:15 PM. Row 436 indicates that User H, User I, and User K are available to participate in an activity at 5:30 PM. Row 438 indicates that User A, User, B, User, C, User D, User E, User F, User G, User H, User I, User J, and User K are available to participate in an activity at 5:45 PM. Row 440 indicates that User A, User, B, User, C, User D, User E, User F, User G, User H, User I, User J, and User K are available to participate in an activity at 6:00 PM.

Distributed hash table 400 is implemented with regard to eleven users (i.e., Users A-K) and periods of time between 9:00 AM-6:00 PM for purposes of illustration and is not intended to be limiting. It will be recognized that hash table 400 may be implemented with regard to any number of users and periods of time.

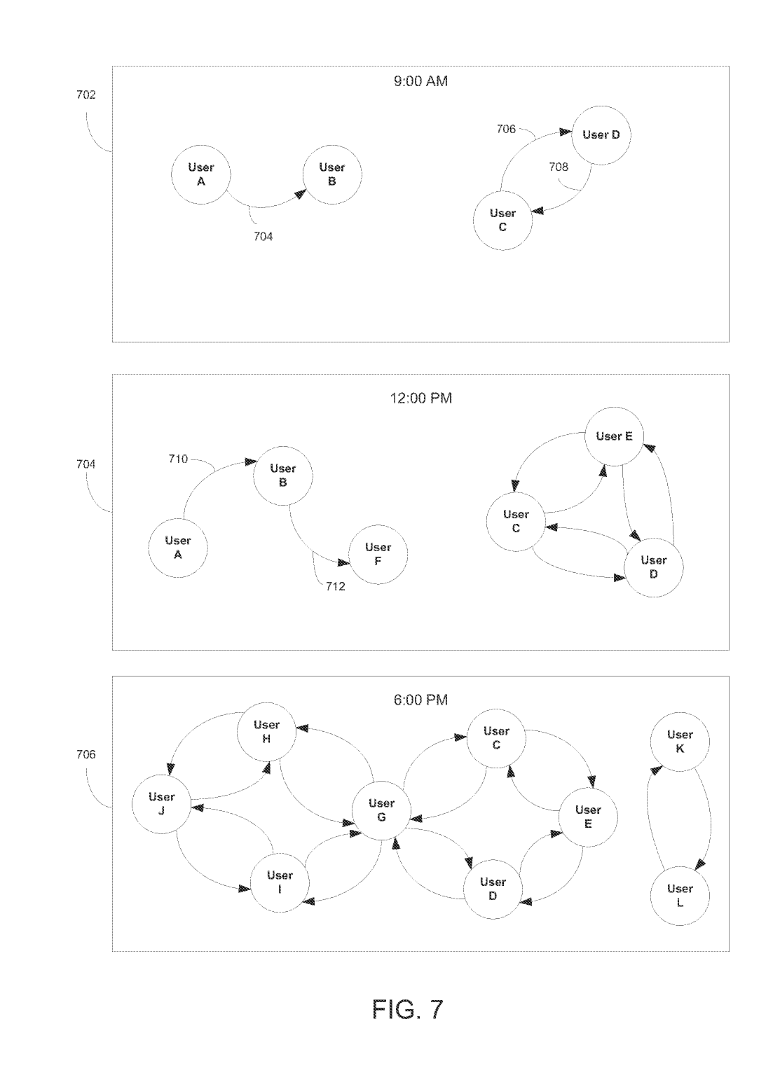

FIG. 5 depicts a flowchart 500 of an example method for determining a measure of compatibility between a subset of users in a group and each of a plurality of offers and presenting the offer having the highest measure of compatibility to the subset of users in accordance with an embodiment described herein. As shown in FIG. 5, the method of flowchart 500 begins at step 502. In step 502, for each of the groups, subset(s) of users are determined based on each user in each subset having a social connection with other user(s) in the respective subset. Further discussion of determining subset(s) of users is provided below with reference to FIGS. 6 and 7.

In an example implementation, grouping logic 1304 determines, for each of the groups, subset(s) of users based on each user in each subset having a social connection with other user(s) in the respective subset. The subset(s) of users are determined using relationship indicator 1344 (described below with reference to FIGS. 6 and 7) received from social connection logic 1312. Once the subset(s) of users are determined, grouping logic 1304 provides the subset(s) of users, to compatibility logic 1306 via subset indicator 1332. In one example embodiment, subset indicator 1332 is stored in store 1320, and compatibility logic 1306 retrieves subset indicator 1332 as needed.

At step 504, for each of the subset(s), a respective second measure of compatibility is determined by comparing the second attribute(s) of each of the users in the subset. The second attribute(s) of each of the users in the subset are compared to determine matches between the second attribute(s). In an example embodiment, the number of matches indicates the second measure of compatibility. Thus, if it is determined that a comparison of second attribute(s) of users in a first subset results in a higher number of matches than a comparison of second attribute(s) of users in a second subset, the first subset has a higher second measure of compatibility than the second subset. The second measure of compatibility determination described above with respect to the second attributes of users in first and second subsets is one example technique and is not intended to be limiting. Other techniques for determining a second measure of compatibility are within the scope of the example embodiments.

In an example implementation, compatibility logic 1306 determines, for each of the subset(s), respective second measure of compatibility 1338 by comparing respective second attribute(s) 1334 of each of the users in the subset. Compatibility logic 1306 retrieves second attribute(s) 1334 from store 1320. Compatibility logic 1306 provides respective second measure of compatibility 1338 to ranking logic 1314.

At step 506, each of the subset(s) are ranked based on the respective second measure of compatibility of each of the subset(s). In an example implementation, ranking logic 1314 ranks each of the subset(s) based on respective second measure of compatibility 1338 and provides highest rank indicator 1340, which indicates the subset having the highest rank, to compatibility logic 1306.

At step 508, for each of the plurality of offers, the second attribute(s) of each user in a designated subset from the subset(s) that has a highest rank among the subset(s) and the third attribute(s) of the respective offer are compared to determine the respective measure of compatibility between the users in the group and the respective offer. The measure of compatibility determination may be performed using the example technique described above in reference to step 204 of FIG. 2. In this case, the second attribute(s) of users in subset of a group (rather than the whole group) are compared to third attribute(s) of the respective offer. It is noted, however, that this measure of compatibility determination technique is one example technique and is not intended to be limiting. Other techniques for determining a measure of compatibility are within the scope of the example embodiments.

In an example implementation, compatibility logic 1306 compares the second attribute(s) 1334 of each user in a designated subset from the subset(s) that has a highest rank among the subset(s) and the third attribute(s) 1336 of the respective offer. Compatibility logic 1316 receives an indication of the designated subset having the highest rank (i.e., highest rank indicator 1340) from ranking logic 1314. Compatibility logic 1316 retrieves second attribute(s) and third attribute(s) retrieved from store 1320.

At step 510, the offer having the highest measure of compatibility is presented to the users in the subset having the highest rank. In an example implementation, presentation logic 1308 presents the offer 1330 to the users in the subset. Presentation logic 1308 retrieves offers 1329 from store 1320.

In an example embodiment, if more than one offer has the highest measure of compatibility among the offers, then all such offers are presented to the subset(s) of the users in the group. In another embodiment, only one of these offers is presented. In accordance with this embodiment, the offers may be sorted (e.g., alphabetically, by the price of the offers, etc.) into a list, and the first offer in the sorted list is presented to the subset(s) of the users in the group. In yet another embodiment, all offers having a measure of compatibility that reach a designated threshold are presented to the user.

In another example embodiment, offer(s), upon determining the subset of users having the highest rank, a determination is made whether any of those users in the subset having the highest rank have already received an offer for the period of time for which the subset was created. If a determination is made that any of the users in the subset have already received such an offer, then the users of the subset are not provided with the offer, and the offer is presented to the subset having the next highest rank. This prevents a user from receiving two offers that do not specify a common group of users (i.e., this prevents double booking of a user).

At step 512, a determination is made whether any of the users in the subset have accepted the offer. If any of the users in the subset have accepted the offer, flow continues to step 514. Otherwise, flow continues to step 516. In an example implementation, notification logic 1318 determines whether any of the users in the subset have accepted the offer via accept/decline indicator 1348. Accept/decline indicator 1348 may be provided to notification logic 1318 in response to a user accepting or declining the offer.

At step 514, the offer provided by the offer is presented to the users in the subset that have accepted the offer. In some example embodiments, the offer is provided via email, short message service (SMS), instant message (IM), or any other suitable messaging technology.

In an example embodiment, an offer is presented to users in a subset that accept the offer if the number of users in the subset that accept the offer reaches a designated threshold. For example, suppose there are 10 users in the subset, and the threshold is set to 5. In this example, if at least 5 of the users accept the offer, then the at least 5 users that accepted the offer are presented with the offer. However, if 4 users accepted the offer, then the offer is not presented to any of the users in the subset.

It is noted that the threshold in the example above is provided for illustrative purposes and is not intended to be limiting. It will be recognized that the threshold may be set to any number (including zero or a number representative of the maximum number of users in a particular subset). As such, the threshold may be set such that the offer is presented to the users of the subset only if all of the users of the subset accept the offer.

At step 516, a determination is made whether all the users in the subset declined the offer. If all of the users in the subset have declined the offer, flow continues to step 518. Otherwise, flow returns to step 512. In an example implementation, notification logic 1318 determines whether all of the users in the subset have declined the offer via accept/decline indicator 1348.

In an example embodiment, flow may transition to step 518 if the number of users in the subset that decline the offer reaches a designated threshold. For example, suppose there are 10 users in the subset, and the threshold is set to 5. In this example, if at least 5 of the users decline the offer, then flow continues to step 518. However, if 4 users have declined the offer, flow continues to step 512.

It is noted that the threshold in the example above is provided for illustrative purposes and is not intended to be limiting. It will be recognized that the threshold may be set to any number (including zero or a number representative of the maximum number of users in a particular subset). As such, the threshold may be set such that flow continues to step 518 if only one user declines the offer.

At step 518, a determination is made whether there are any more offers to present to the users in the subset. If there are more offers to present to the user, flow continues to step 520. Otherwise, flowchart 500 ends. In an example implementation, presentation logic 1308 presents the offer 1330 to the users in the subset. Presentation logic 1308 retrieves offers 1329 from store 1320.

At step 520, the offer having the next highest measure of compatibility to the users in the subset is presented to the users in the subset. In an example implementation, presentation logic 1308 presents the offer having the next highest measure of compatibility to the users in the subset. Presentation logic 1308 retrieves offers 1329 from store 1320.

In some example embodiments, one or more steps 502, 504, 506, 508, 510, 512, 514, 516, 518, and/or 520 of flowchart 500 may not be performed. Moreover, steps in addition to or in lieu of steps 502, 504, 506, 508, 510, 512, 514, 516, 518, and/or 520 may be performed.

FIG. 6 depicts a flowchart 600 of an example method for determining one or more subsets of users from the plurality of users in the group in accordance with an embodiment described herein. As shown in FIG. 6, the method of flowchart 600 begins at step 602. At step 602, a directed graph is created that includes nodes and directed link(s). Each of the nodes corresponds to a respective user in the group. Each of the directed link(s) connects one node to another to indicate a social connection between the respective corresponding users in the group.

In an example implementation, graphing logic 1316 creates directed graph 1342 using group indicator 1326 and social data 1350. Group indicator 1326 is provided by graphing logic 1304 and indicates the users in each of the determined groups. Social data 1350 indicates the social connections that each user has in each of the groups. In an example embodiment, graphing logic 1316 retrieves social data 1350 from social network 116 via an application programming interface (API). In another example embodiment, analytic engine 1302 periodically collects social data 1350 from social network 116 and stores social data 1350 into store 1320. In this example embodiment, graphing logic 1316 retrieves social data 1350 from store 1320 when creating directed graph 1342. Graphing logic 1316 provides directed graph 1342 to social connection logic 1312. In another example embodiment, grouping logic 1304 stores group indicator 1326 into store 1320 (e.g., as a directed hash table). In this example embodiment, graphing logic 1316 retrieves group indicator 1326 from store 1320 when creating directed graph 1342.

An example of a directed graph is shown in FIG. 7, which depicts groups 702, 704, and 706 that are represented by respective directed graphs in accordance with an embodiment herein. Each of the groups 702, 704, and 706 includes users that have been grouped together based on a common period of time in which the users are available to participate in an activity. For example, group 702 includes users (e.g., User A, User B, User C, User D, and User E) that are available at 9:00 AM, group 704 includes users (e.g., User A, User B, User C, User D, User E, and User F) that are available at 12:00 PM, and group 706 includes users (e.g., User C, User D, User E, User G, User H, User I, User J, User K, and User L) that are available at 6:00 PM.

Group 702 includes a directed graph depicting two subsets of users. The first subset includes User A and User B, where User A is connected to User B via directed link 704. However, User B is not connected to User A. This type of relationship may be referred to as a non-reciprocal relationship, where a first user (e.g., User A) has made a social connection with second user (e.g., User B), but the second user has not made a social connection with first user. Examples of a non-reciprocal relationship include a user following another user via a microblogging website (e.g., Twitter™, Tumblr™, Plurk™, Emote.in™, Squeelr™, Beeing™, Jaiku™ and Identica.ca™), a user following another user's blog via a blogging website (e.g., Blogger™ WordPress™, and Livejournal™), and/or the like. Another example of a non-reciprocal relationship is a first user including a second user in a white list of friends, but the second user including the first user in a black list of friends. Yet another example of a non-reciprocal relationship is a first user including a second user in his or her contacts list, and the second user not including the first user in his or her contacts list.

The second subset of users in group 702 includes User C and User D. In this subset, User C is connected to User D via directed link 706, and User D is connected to User C via directed link 708. This type of relationship may be referred to as a reciprocal relationship, where a first user (e.g., User C) and a second user (e.g., User D) have made a social connection with each other. This type of relationship may also be referred to as a cycle because each user in the subset has made a social connection with at least one other user in the subset (i.e., User C is connected to User D, and User D is connected to User C). Examples of a reciprocal relationship include two users becoming “friends” via a social networking website (e.g., Facebook™, Myspace™, Linkedin™, and Xing™). A reciprocal relationship may also be formed via a microblogging website when a first user and a second user follow each other. Another example of a reciprocal relationship is a first user and a second user including each other in a white list of friends. Yet another example of a reciprocal relationship is a first user and a second user including each other in their respective contacts list.

Returning now to the process of flowchart 600, at step 604, the directed graph is analyzed to determine whether a predetermined type of relationship is formed among the nodes. In an example implementation, social connection logic 1312 analyzes directed graph 1342 provided by graphing logic 1316 to determine whether a predetermined type of relationship is formed among the nodes.

A predetermined type of relationship may be designated by a user or a vendor. Alternatively, a default predetermined type of relationship may be designated by automated offer system 1300 if a user or a vendor does not designate the predetermined type of relationship. One example of a predetermined type of relationship is a non-reciprocal relationship between two users (such as the one shown between User A and User B of group 702 in FIG. 7). Another example of a predetermined type of relationship is a reciprocal relationship between any numbers of users. For example, referring to FIG. 7, group 702 depicts a reciprocal relationship between two users (User A and User B), and group 704 depicts a reciprocal relationship between three users (User C, User D, and User E).

Yet another example of a predetermined type of relationship is a where a first user is connected to a second user, the second user is connected to a third user, but the third user is not connected the first user (i.e., the third user is a friend of a friend of the first user). This type of relationship is shown in between User A, User B, and User F of group 704 depicted in FIG. 7. Here, User A is connected to User B via directed link 710, and User B is connected to User F via directed link 712. However, User F is not connected to User A.

Yet another example of a predetermined type of relationship is a set of cycles that share a common node (i.e., two or more groups of friends that have a common friend). This type of relationship is shown in group 706 depicted in FIG. 7. Group 706 includes two subsets of users. The first subset includes User C, User D, User E, User G, User H, User I, and User J, and the second subset includes User K and User L.

A first cycle is formed between User C, User D, User E, and User G because each of these users is connected to at least one other user in the first subset. A second cycle is formed between User G, User H, User I, and User J because each of these users is connected to at least one other user in the first subset. The common node in this example is User G because both cycles include User G.

The predetermined types of relationship described above are merely different examples of predetermined types of relationships and are not intended to be limiting. Other examples of predetermined types of relationships are within the scope of the example embodiments.

In an example embodiment, a predetermined type of relationship is defined to include a cycle of nodes that includes no more than a specified number of nodes. If the number of nodes of a cycle exceeds the specified number of nodes, then the cycle is not included in the analysis. However, if the number of nodes of a cycle does not exceed the specified number of nodes, then the cycle is included in the analysis.

In another example embodiment, a predetermined type of relationship is defined to include a plurality of cycles in which each cycle shares at least a first designated number of common nodes with at least one other cycle in the plurality of cycles. For example, if the number of common nodes between the sets of cycles exceeds the first designated number of common nodes, then the sets of cycles are not included as part of the analysis. However, if the number of common nodes between the sets of cycles does not exceed the first designated number of common nodes, then the sets of cycles are included as part of the analysis. In one example embodiment, a value of the first designated number of common nodes may be a function of the total number of nodes that are included among the sets of cycles. For example, the greater the total number of nodes that are included among the sets of cycles, the greater the first designated number of common nodes may be. In contrast, the lesser the total number of nodes that are included among the sets of cycles, the lesser the first designated number of common nodes may be. In another example embodiment, a value of the first designated number of common nodes may be a function of a second designated number of nodes in a respective cycle. For example, the greater the second designated number of cycles in the respective cycle, the greater the first designated number of common nodes may be. In contrast, the lesser the second designated number of nodes in a respective cycle, the lesser the first designated number of common nodes may be.

At step 606, a determination is made whether the predetermined type of relationship has been formed. If it is determined that the predetermined type of social connection has been formed, then flow continues to 608. Otherwise, flow continues to step 610. In an example implementation, social connection logic 1312 analyzes directed graph 1342 provided by graphing logic 1316 to determine whether a predetermined type of relationship is formed among the nodes. If a predetermined type of relationship is formed, a relationship indicator 1344, which indicates the nodes that form the predetermined type of relationship, is provided to grouping logic 1304.

At step 608, user(s) which correspond to respective node(s) that form the predetermined type of relationship are designated to define a first subset of the subset(s) of users in the group. The designation is in response to a determination that the predetermined type of relationship is formed among the nodes. In an example implementation, grouping logic 1304 designates the users to define a first subset of the subset(s) of users in the group. Grouping logic 1304 determines that the predetermined type of relationship is formed via relationship indicator 1344 provided by social connection logic 1312 and provides the designation to compatibility logic 1306 via subset indicator 1332.

At step 610, a determination is made whether another predetermined type of relationship has been formed. If it is determined that another predetermined type of relationship has been formed, then flow continues to 612. Otherwise, flowchart 600 ends. In an example implementation, social connection logic 1312 analyzes directed graph 1342 provided by graphing logic 1316 to determine whether another predetermined type of relationship is formed among the nodes. If a predetermined type of relationship is formed, relationship indicator 1344, which indicates the nodes that form the predetermined type of relationship, is provided to grouping logic 1304.

In an example embodiment, a user, a vendor, or automated offer system 1300 indicates multiple predetermined types of relationships. These predetermined types of relationships may be ranked, where the most preferred predetermined type of relationship is ranked the highest, and the least preferred predetermined type of relationship is ranked the lowest. Accordingly, if a predetermined type of relationship having the highest rank is not found, then a search for a predetermined type of relationship having the next highest rank is performed.

At step 612, user(s) which correspond to respective node(s) that form the other predetermined type of relationship are designated to define a first subset of the subset(s) of users in the group. The designation is in response to a determination that the other predetermined type of relationship is formed among the nodes. In an example implementation, grouping logic 1304 designates the users to define a first subset of the subset(s) of users in the group. Grouping logic 1304 determines that the other predetermined type of relationship is formed via relationship indicator 1344 provided by social connection logic 1312 and provides the designation to compatibility logic 1306 via subset indicator 1332.

In some example embodiments, one or more steps 602, 604, 606, 608, 610, and/or 612 of flowchart 600 may not be performed. Moreover, steps in addition to or in lieu of steps 602, 604, 606, 608, 610, and/or 612 may be performed.

FIG. 8 depicts a flowchart 800 of an example method for presenting at least one selected offer to specified users in accordance with an embodiment described herein. As shown in FIG. 8, the method of flowchart 800 begins at step 802. At step 802, for each of the groups, a notification that specifies the selected offer(s) is sent. The specified users include subset(s) of users in the group. A subset of users in the group may be determined in accordance with the example method described in reference to flowchart 600. It is noted, however, that this subset determination technique is one example technique and is not intended to be limiting. Other techniques for determining subset(s) are within the scope of the example embodiments. In an example implementation, notification logic 1318 sends the notification (via notification indicator 1346) to the specified users.

In an example embodiment, the notification is provided via email, short message service (SMS), instant message (IM), or any other suitable messaging technology.

At step 804, an update is sent to a respective calendar application of each of the specified users. The update is configured to create an entry in the respective calendar application corresponding to a time and/or a date on which the selected offer(s) are redeemable. In one example embodiment, the entry includes a description of the selected offer(s) and an identifier for each of the specified users. In another example embodiment, the entry also includes an identifier for each of the specified users that have accepted the offer, an identifier for each of the specified users that have declined the offer, and/or an identifier for each of the specified users who have not yet accepted or declined the offer. In an example implementation, notification logic 1318 sends the update (via update indicator 1347) to the specified users.

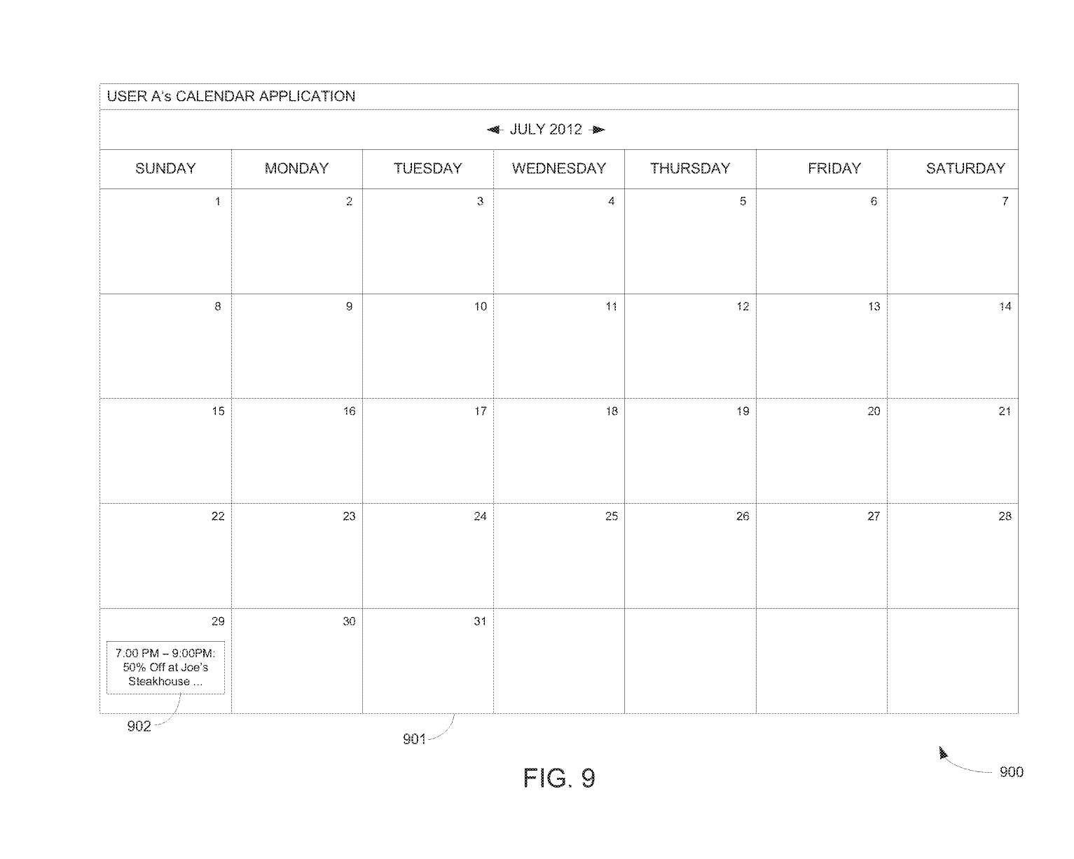

An example of an update to a calendar application is shown in FIGS. 9, 10, 11, and 12. FIGS. 9, 10, 11, and 12 are illustrations of example graphical user interfaces (GUIs) 900, 1000, 1100, and 1200 for a calendar application in accordance with embodiments described herein. GUIs 900, 1000, 1100, and 1200 may be represented as respective Web pages, though the scope of the example embodiments is not limited in this respect. GUIs 900, 1000, 1100, and 1200 will be described with respect to a hypothetical scenario in which the selected offer is for a 50% off coupon for Joe's Steakhouse. The selected offer is valid from 7:00 PM-9:00 PM on Jul. 29, 2012 and has been sent to the following specified users: User A, User B, User C, User D, User E, User F, User G, User H, User I, User J, and User K.

As shown in FIG. 9, GUI 900 depicts calendar application 901 of User A and update 902. Calendar application 901 may be an example of calendar application 127 depicted in FIG. 1, according to an embodiment. Update 902 has been created in an entry of calendar application 901 corresponding to a time and date on which the selected offer is valid. Update 902 may be configured as an appointment in calendar application 901.

Because the selected offer is valid from 7:00 PM to 9:00 PM on Jul. 29, 2012, the update has been added to the entry of calendar application 901 corresponding to this time and date. User A may obtain more information regarding update 902 by selecting update 902. Update 902 may be selected, for example, via a mouse click, by hovering a cursor over update 902 for a predetermined time interval, saying a voice command that is directed to selecting update 902, performing a gesture that is directed to selecting update 902, and/or the like.

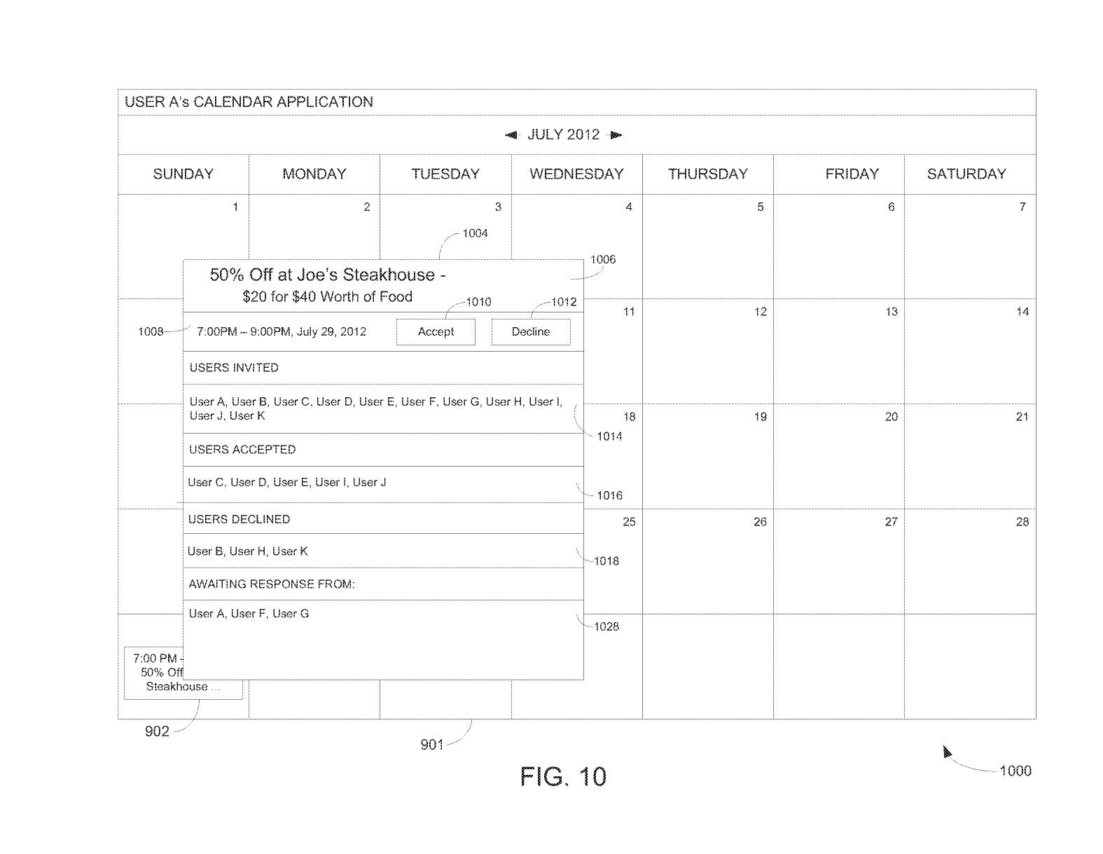

As shown in FIG. 10 update 902 has been selected by User A, and a detailed view 1004 of update 902 is displayed. Detailed view 1004 includes a description field 1006, a time and date field 1008, a first interface element 1010 (e.g., a button), a second interface element 1012, an invited field 1014, an accepted field 1016, a declined field 1018, and an awaiting responses field 1020. Description field 1006 includes a detailed description of the selected offer. Description field may include information such as the name of the vendor providing the offer, the operating hours of the vendor providing the offer, the address of the vendor providing the offer, a distance of the vendor from the user for whom update 902 is provided, the price of the offer, etc. Time and date field 1008 includes the time and date in which the offer is redeemable. First interface element 1010 allows the user for which update 902 is provided to accept the offer upon selection. Second interface element 1012 allows the user for which update 902 is provided to decline the offer upon selection. Invited field 1014 indicates the specified user(s) that have been provided the offer. Accepted field 1016 indicates the specified user(s) that have accepted the offer. Declined field 1018 indicates the specified user(s) that have declined the offer. Awaiting responses field 1020 indicates the specified user(s) who have not yet accepted or declined the offer.

Returning now to the process of flowchart 800, at step 806, a determination is made whether one of the specified users either accepted or declined the selected offer(s). If a determination is made that one of the specified users either accepted or declined the selected offer(s), flow continues to step 808. Otherwise, flow continues to step 810. In an example implementation, notification logic 1318 determines whether one of the specified users either accepted or declined the selected offer(s) via accept/decline indicator 1348. Accept/decline indicator 1348 may be provided to notification logic 1318 in response to a user accepting or declining the offer (e.g., via selection of interface element 1010 or interface element 1012).

At step 808, another update is sent to the respective calendar application of each of the specified users. The update is configured to modify the entry in the respective calendar application. The modification includes an indication that a particular specified user has either accepted or declined the selected offer(s). In an example implementation, notification logic 1318 sends the other update (via update indicator 1347) to the specified users.

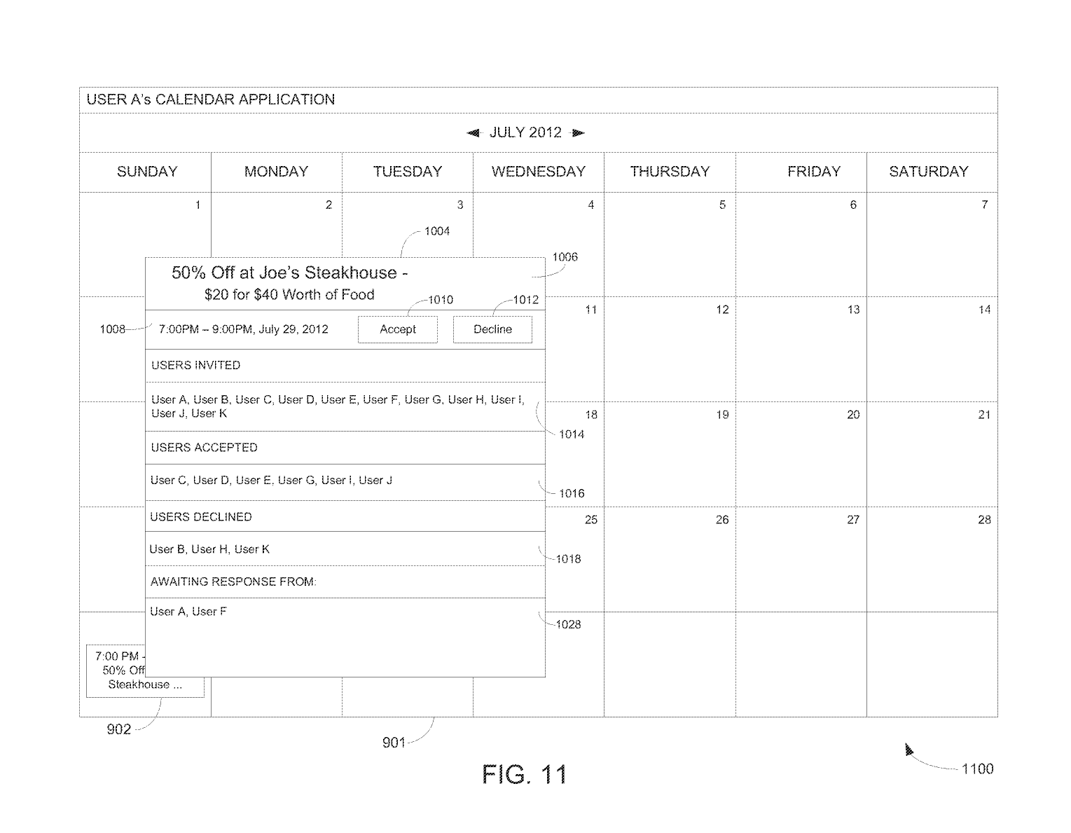

For example, using the example depicted in FIG. 10, suppose that User G has accepted the selected offer by selecting the appropriate interface element on his or her respective calendar application. In response, an update is sent to each of the specified users. For example, as shown in FIG. 11, calendar application 901 of User A receives an update that modifies entry 902. As shown, entry 902 has been modified such that User G has been removed from awaiting responses field 1028 and has been added to accepted field 1016.

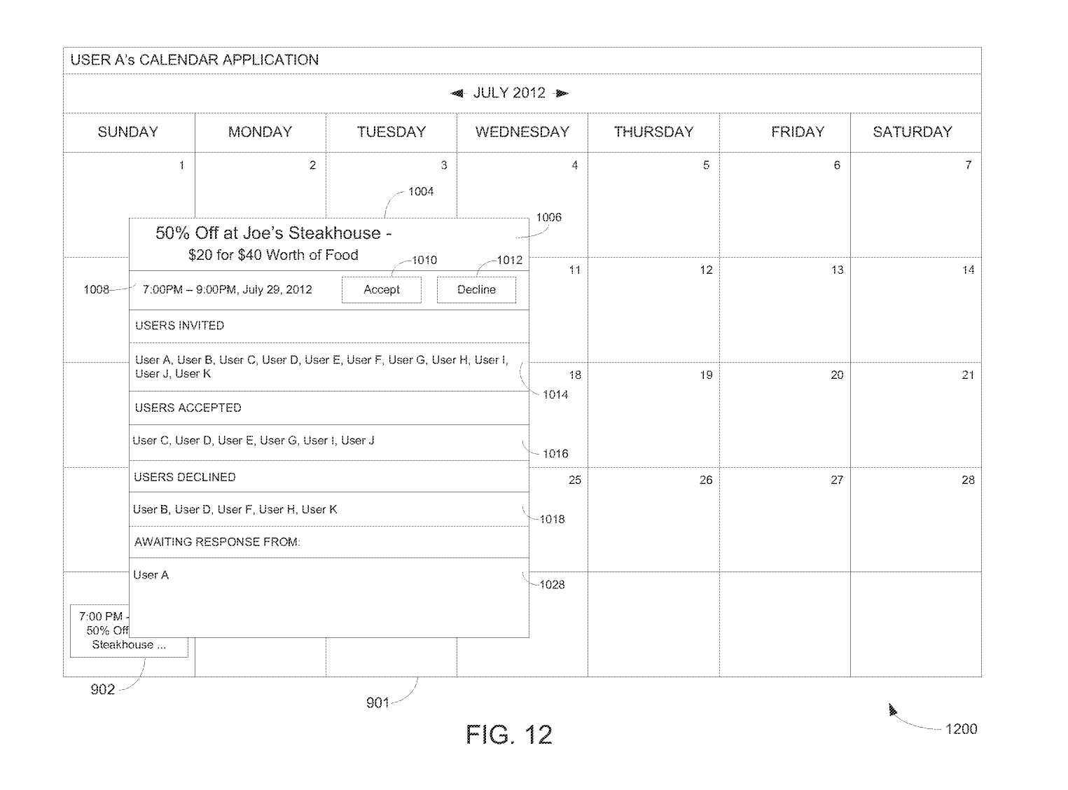

Now further suppose that User D has declined the selected offer by selecting the appropriate interface element on his or her respective calendar application. In response, an update is sent to each of the specified users. For example, as shown in FIG. 12, calendar application 901 of User A receives an update that modifies entry 902. As shown, entry 902 has been modified such that User D has been removed from awaiting responses field 1028 and has been added to declined field 1018.

It is noted that GUIs 900, 1000, 1100, and 1200 may include additional updates, fields and/or interfaces that are not depicted. For example, calendar application 901 may present a plurality of selected offer(s) via updates. The selected offer(s) may be scheduled during different time periods, or during the same time period as another update. In the event that more than one selected offer is provided during the same time period, the detailed view of the update may include interface elements that allow the user to traverse (e.g., scroll through) multiple selected offer(s) scheduled for that same time period. For example, one interface element, upon selection, may allow a user to view a different selected offer scheduled for that same time period. Another interface element, upon selection, may allow a user to view a selected offer that was previously shown to the user.

Furthermore, in addition to or in lieu of interface elements 1010 and 1012, the detailed view 1004 of the update may include interface elements that are configured to allow a user to vote in favor of or against a particular selected offer. In response to voting for the particular selected offer, an update is sent to the respective calendar application of each of the specified users, which modifies the corresponding entry in the respective calendar application. The modification includes an indication that a particular specified user has either voted for or voted against the selected offer(s).

While not shown, it will be appreciated that GUIs 900, 1000, 1100, and 1200 may display other types of content in addition to or in lieu of textual content, such as pictures, videos, advertisements, etc. In addition, it is noted that the locations and/or sizes of the various updates, fields and/or interface elements shown in FIGS. 9, 10, 11, and 12 can vary. Thus, the example described above with reference to FIGS. 9, 10, 11, and 12 is provided for illustrative purposes and is not intended to be limiting.

Returning now to the process of flowchart 800, at step 810, if none of the specified users either accepted or declined the selected offer(s), the other update is not sent to the respective calendar application of each of the specified users. In an example implementation, notification logic 1318 does not send the other update to the calendar applications of the respective specified users if none of the specified users either accepted or declined the selected offer(s).

In some example embodiments, one or more steps 802, 804, 806, 808, and/or 810 of flowchart 800 may not be performed. Moreover, steps in addition to or in lieu of steps 802, 804, 806, 808, and/or 810 may be performed.

It will be recognized that automated offer system 1300 and analytic engine 1302 may not include one or more of grouping logic 1304, compatibility logic 1306, presentation logic 1308, data mining 1310, social connection logic 1312, ranking logic 1314, graphing logic 1316, and/or notification logic 1318. Furthermore, automated offer system 1300 and analytic engine 1302 may include logic in addition to or in lieu of grouping logic 1304, compatibility logic 1306, presentation logic 1308, data mining 1310, social connection logic 1312, ranking logic 1314, graphing logic 1316, and/or notification logic 1318.

### III. Other Example Embodiments

Automated offer system 120, analytic engine 122, consumer user interface 124, business user interface 126, calendar application 127, calendar application 901, automated offer system 1300, analytic engine 1302, grouping logic 1304, compatibility logic 1306, presentation logic 1308, data mining 1310, social connection logic 1312, ranking logic 1314, graphing logic 1316, and/or notification logic 1318 may be implemented in hardware, or any combination of hardware with software and/or firmware. For example, automated offer system 120, analytic engine 122, consumer user interface 124, business user interface 126, calendar application 127, calendar application 901, automated offer system 1300, analytic engine 1302, grouping logic 1304, compatibility logic 1306, presentation logic 1308, data mining 1310, social connection logic 1312, ranking logic 1314, graphing logic 1316, and/or notification logic 1318 may be implemented as computer program code configured to be executed in one or more processors. In another example, automated offer system 120, analytic engine 122, consumer user interface 124, business user interface 126, calendar application 127, calendar application 901, automated offer system 1300, analytic engine 1302, grouping logic 1304, compatibility logic 1306, presentation logic 1308, data mining 1310, social connection logic 1312, ranking logic 1314, graphing logic 1316, and/or notification logic 1318 may be implemented as hardware logic/electrical circuitry.

### IV. Example Computer Implementation

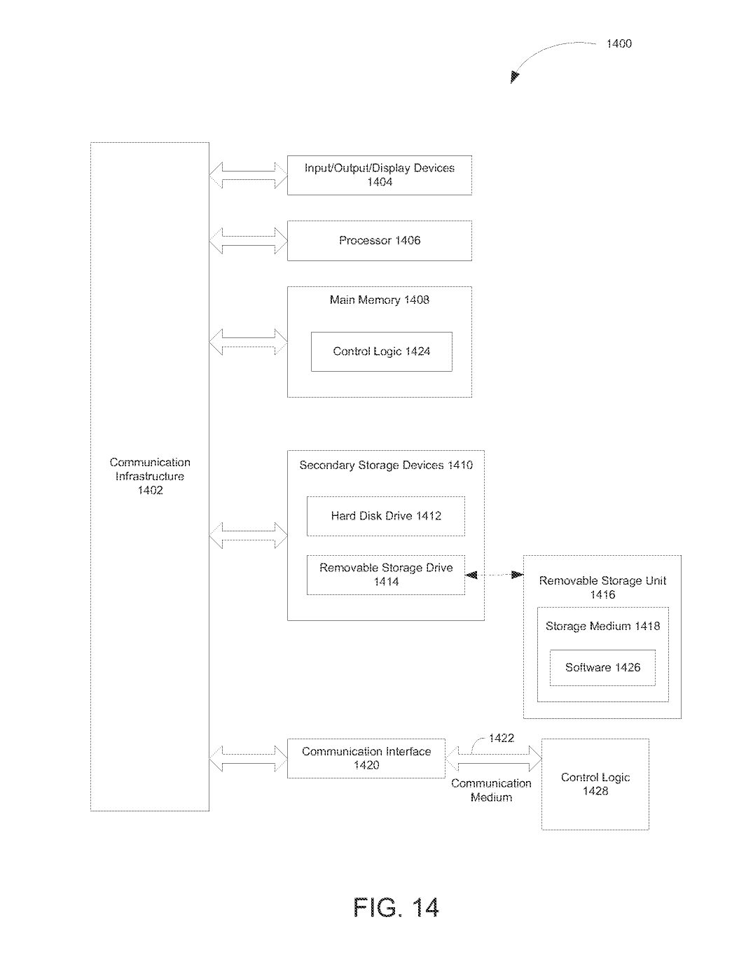

The embodiments described herein, including systems, methods/processes, and/or apparatuses, may be implemented using well known servers/computers, such as computer 1400 shown in FIG. 14. For instance, elements of example system 100, including any of the user systems 102, 104, 106, and 108, publisher server 118, and/or vendor system 128 depicted in FIG. 1 and elements thereof, each of the steps of flowchart 200 depicted in FIG. 2, each of the steps of flowchart 300 depicted in FIG. 3, each of the steps of flowchart 500 depicted in FIG. 5, each of the steps of flowchart 600 depicted in FIG. 6, and/or each of the steps of flowchart 800 depicted in FIG. 8 can each be implemented using one or more computers 1400.

Computer 1400 can be any commercially available and well known computer capable of performing the functions described herein, such as computers available from International Business Machines, Apple, Sun, HP, Dell, Cray, etc. Computer 1400 may be any type of computer, including a desktop computer, a server, etc.

As shown in FIG. 14, computer 1400 includes one or more processors (e.g., central processing units (CPUs)), such as processor 1406. Processor 1406 may include automated offer system 120, analytic engine 122, consumer user interface 124, business user interface 126 and/or calendar application 127 of FIG. 1; analytic engine 1302, grouping logic 1304, compatibility logic 1306, presentation logic 1308, data mining 1310, social connection logic 1312, ranking logic 1314, graphing logic 1316, and/or notification logic 1318 of FIG. 13; or any portion or combination thereof, for example, though the scope of the embodiments is not limited in this respect. Processor 1406 is connected to a communication infrastructure 14302, such as a communication bus. In some embodiments, processor 1406 can simultaneously operate multiple computing threads.

Computer 1400 also includes a primary or main memory 1408, such as a random access memory (RAM). Main memory has stored therein control logic 1424 (computer software), and data.

Computer 1400 also includes one or more secondary storage devices 1410. Secondary storage devices 1410 include, for example, a hard disk drive 1412 and/or a removable storage device or drive 1414, as well as other types of storage devices, such as memory cards and memory sticks. For instance, computer 1400 may include an industry standard interface, such as a universal serial bus (USB) interface for interfacing with devices such as a memory stick. Removable storage drive 1414 represents a floppy disk drive, a magnetic tape drive, a compact disk drive, an optical storage device, tape backup, etc.

Removable storage drive 1414 interacts with a removable storage unit 1416. Removable storage unit 1416 includes a computer useable or readable storage medium 1418 having stored therein computer software 1426 (control logic) and/or data. Removable storage unit 1416 represents a floppy disk, magnetic tape, compact disc (CD), digital versatile disc (DVD), Blu-ray disc, optical storage disk, memory stick, memory card, or any other computer data storage device. Removable storage drive 1414 reads from and/or writes to removable storage unit 1416 in a well-known manner.

Computer 1400 also includes input/output/display devices 1404, such as monitors, keyboards, pointing devices, microphones, motion capture devices, etc.

Computer 1400 further includes a communication or network interface 1420. Communication interface 1420 enables computer 1400 to communicate with remote devices. For example, communication interface 1420 allows computer 1400 to communicate over communication networks or mediums 1422 (representing a form of a computer useable or readable medium), such as local area networks (LANs), wide area networks (WANs), the Internet, etc. Network interface 1420 may interface with remote sites or networks via wired or wireless connections. Examples of communication interface 1422 include but are not limited to a modem, a network interface card (e.g., an Ethernet card), a communication port, a Personal Computer Memory Card International Association (PCMCIA) card, etc.

Control logic 1428 may be transmitted to and from computer 1400 via the communication medium 1422.

Any apparatus or manufacture comprising a computer useable or readable medium having control logic (software) stored therein is referred to herein as a computer program product or program storage device. This includes, but is not limited to, computer 1400, main memory 1408, secondary storage devices 1410, and removable storage unit 1416. Such computer program products, having control logic stored therein that, when executed by one or more data processing devices, cause such data processing devices to operate as described herein, represent embodiments of the invention.

For example, each of the elements of automated offer system 120, analytic engine 122, consumer user interface 124, business user interface 126 and/or calendar application 127 depicted in FIG. 1; analytic engine 1302, grouping logic 1304, compatibility logic 1306, presentation logic 1308, data mining 1310, social connection logic 1312, ranking logic 1314, graphing logic 1316, and/or notification logic 1318, each depicted in FIG. 13; each of the steps of flowchart 200 depicted in FIG. 2; each of the steps of flowchart 300 depicted in FIG. 3; each of the steps of flowchart 500 depicted in FIG. 5; each of the steps of flowchart 600 depicted in FIG. 6; and/or each of the steps of flowchart 800 depicted in FIG. 8 can be implemented as control logic that may be stored on a computer useable medium or computer readable medium, which can be executed by one or more processors to operate as described herein.

Computer readable storage media are distinguished from and non-overlapping with communication media. Communication media typically embodies computer-readable instructions, data structures, program modules or other data in a modulated data signal such as a carrier wave. The term “modulated data signal” means a signal that has one or more of its characteristics set or changed in such a manner as to encode information in the signal. By way of example, and not limitation, communication media includes wireless media such as acoustic, RF, infrared and other wireless media. Example embodiments are also directed to such communication media.

### V. Conclusion

While various embodiments have been described above, it should be understood that they have been presented by way of example only, and not limitation. It will be apparent to persons skilled in the relevant art(s) that various changes in form and details can be made therein without departing from the spirit and scope of the invention. Thus, the breadth and scope of the present invention should not be limited by any of the above-described exemplary embodiments, but should be defined only in accordance with the following claims and their equivalents.

The proper interpretation of subject matter described and claimed herein is limited to patentable subject matter under 35 U.S.C. §101. As described and claimed herein, a method is a process defined by 35 U.S.C. §101. As described and claimed herein, each of a device, apparatus, machine, system, computer, module, computer readable media, media, is a machine or manufacture defined by 35 U.S.C. §101.

What is claimed is:

1. A method, comprising:
determining a plurality of groups of users of a social networking system, each of the plurality of groups including a plurality of users, based on the plurality of users in each of the plurality of groups having at least one respective first attribute in common; and
for each of the plurality of groups:
determining a measure of compatibility between the plurality of users in the group and each of a plurality of offers by comparing at least one second attribute of each of the plurality of users in the group and at least one third attribute of the respective offer, each of the plurality of offers specifying a price of at least one commerce element; and
presenting at least one selected offer selected from the plurality of offers to at least a subset of the plurality of users in the group in response to the at least one selected offer having a highest measure of compatibility among the plurality of offers.

2. The method of claim 1, wherein determining a plurality of groups of users of a social networking system comprises:
retrieving respective calendar data from each of the users of the social networking system to determine the at least one respective first attribute, the at least one respective first attribute indicating a period of time in which the respective user of the social networking system is available to participate in an activity; and
assigning a respective plurality of users that each have the at least one respective first attribute indicating a common period of time in which each of the respective plurality of users is available to participate in an activity to a respective group of the plurality of groups.

3. The method of claim 1, wherein for each of the plurality of groups, determining a measure of compatibility comprises:
for each of the plurality of groups:
determining one or more subsets of users from the plurality of users in the group based on each user in each subset having a social connection with at least one other user in the respective subset;
for each of the one or more subsets, determining a respective second measure of compatibility by comparing the at least one second attribute of each of the users in the subset;
ranking each of the one or more subsets based on the respective second measure of compatibility; and
for each of the plurality of offers, comparing the at least one second attribute of each user in a designated subset from the one or more subsets that has a highest rank among the one or more subsets and the at least one third attribute of the respective offer to determine the respective measure of compatibility between the plurality of users in the group and the respective offer.

4. The method of claim 3, wherein for each of the plurality of groups, determining one or more subsets of users from the plurality of users in the group comprises:
for each of the plurality of groups:
creating a directed graph that includes a plurality of nodes and one or more directed links, each of the plurality of nodes corresponding to a respective user of the plurality of users in the group, each of the one or more directed links connecting one node of the plurality of nodes to another node of the plurality of nodes to indicate a social connection between the respective corresponding users of the plurality of users in the group;
analyzing the directed graph to determine whether a predetermined type of relationship is formed among the plurality of nodes; and
designating one or more users, which correspond to one or more respective nodes that form the predetermined type of relationship, to define a first subset of the one or more subsets of users from the plurality of users in the group in response to a determination that the predetermined type of relationship is formed among the plurality of nodes.

5. The method of claim 4, wherein the predetermined type of relationship is defined to include a cycle of nodes that includes no more than a specified number of nodes.

6. The method of claim 4, wherein the predetermined type of relationship is defined to include a plurality of cycles in which each cycle shares at least a first designated number of common nodes with at least one other cycle in the plurality of cycles for each second designated number of nodes in the respective cycle.

7. The method of claim 1, wherein for each of the plurality of groups, presenting at least one selected offer comprises:
for each of the plurality of groups:
sending a notification that specifies the at least one selected offer to specified users, the specified users including at least the subset of the plurality of users in the group; and
sending an update to a respective calendar application of each of the specified users, the update configured to create an entry in the respective calendar application corresponding to a time and a date on which the at least one selected offer is valid, the entry including a description of the at least one selected offer and an identifier for each of the specified users.

8. The method of claim 1, wherein the at least one third attribute of the respective offer comprises at least one of:
a location of an activity offered by a vendor that provides the respective offer;
a description of an activity offered by the vendor; or
a time and a date on which an activity provided by the vendor is made available.

9. The method of claim 1, wherein, for each of the plurality of groups, the at least one second attribute of each user in the group comprises at least one of:
a geographic region associated with the user;
one or more interests of the user; or
one or more preferences of the user, the one or more preferences including at least one of:
an indication of other users with whom the user is interested in participating in a specified activity;
an indication of a number of users with whom the user is interested in participating in a specified activity; or
an indication of a distance that the user is willing to travel to participate in a specified activity.

10. A system, comprising:
grouping logic configured to determine a plurality of groups of users of a social networking system, each of the plurality of groups including a plurality of users, based on the plurality of users in each of the plurality of groups having at least one respective first attribute in common;
compatibility logic configured to, for each of the plurality of groups, determine a measure of compatibility between the plurality of users in the group and each of a plurality of offers by comparing at least one second attribute of each of the plurality of users in the group and at least one third attribute of the respective offer, each of the plurality of offers specifying a price of at least one commerce element; and
presentation logic configured to, for each of the plurality of groups, present at least one selected offer selected from the plurality of offers to at least a subset of the plurality of users in the group in response to the at least one selected offer having a highest measure of compatibility among the plurality of offers.

11. The system of claim 10, further comprising:
data mining logic configured to retrieve respective calendar data from each of the users of the social networking system to determine the at least one respective first attribute, the at least one respective first attribute indicating a period of time in which the respective user of the social networking system is available to participate in an activity;
wherein the grouping logic is further configured to assign a respective plurality of users that each have the at least one respective first attribute indicating a common period of time in which each of the respective plurality of users is available to participate in an activity to a respective group of the plurality of groups.

12. The system of claim 10, wherein the grouping logic is further configured to, for each of the plurality of groups, determine one or more subsets of users from the plurality of users in the group based on each user in each subset having a social connection with at least one other user in the respective subset; and
wherein the compatibility logic is further configured to, for each of the one or more subsets for each of the plurality of groups, determine a respective second measure of compatibility by comparing the at least one second attribute of each of the users in the subset.

13. The system of claim 12, further comprising:
ranking logic configured to, for each of the plurality of groups, rank each of the one or more subsets based on the respective second measure of compatibility;
wherein the compatibility logic is further configured to, for each of the plurality of groups, compare the at least one second attribute of each user in a designated subset from the one or more subsets that has a highest rank among the one or more subsets and the at least one third attribute of the respective offer for each of the plurality of offers to determine the respective measure of compatibility between the plurality of users in the group and the respective offer.

14. The system of claim 13, the further comprising:
graphing logic configured to, for each of the plurality of groups, create a directed graph that includes a plurality of nodes and one or more directed links, each of the plurality of nodes corresponding to a respective user of the plurality of users in the group, each of the one or more directed links connecting one node of the plurality of nodes to another node of the plurality of nodes to indicate a social connection between the respective corresponding users of the plurality of users in the group; and
social connection logic configured to, for each of the plurality of groups, analyze the directed graph to determine whether a predetermined type of relationship is formed among the plurality of nodes;
wherein the grouping logic is further configured to, for each of the plurality of groups, designate one or more users, which correspond to one or more respective nodes that form the predetermined type of relationship, to define a first subset of the one or more subsets of users from the plurality of users in the group in response to a determination that the predetermined type of relationship is formed among the plurality of nodes.

15. The system of claim 14, wherein the predetermined type of relationship is defined to include a cycle of nodes that includes no more than a specified number of nodes.

16. The system of claim 14, wherein the predetermined type of relationship is defined to include a plurality of cycles in which each cycle shares at least a first designated number of common nodes with at least one other cycle in the plurality of cycles for each second designated number of nodes in the respective cycle.

17. The system of claim 10, further comprising:
notification logic configured to, for each of the plurality of groups, send a notification that specifies the at least one selected offer to specified users, the specified users including at least the subset of the plurality of users in the group;
wherein the notification logic is further configured to send an update to a respective calendar application of each of the specified users, the update configured to create an entry in the respective calendar application corresponding to a time and a date on which the at least one selected offer is valid, the entry including a description of the at least one selected offer and an identifier for each of the specified users.

18. The system of claim 10, wherein the at least one third attribute of the respective offer comprises at least one of:
a location of an activity offered by a vendor that provides the respective offer;
a description of an activity offered by the vendor; or
a time and a date on which an activity provided by the vendor is made available.

19. The system of claim 10, wherein, for each of the plurality of groups, the at least one second attribute of each user in the group comprises at least one of:
a geographic region associated with the user;
one or more interests of the user; or
one or more preferences of the user, the one or more preferences including at least one of:
an indication of other users with whom the user is interested in participating in a specified activity;
an indication of a number of users with whom the user is interested in participating in a specified activity; or
an indication of a distance that the user is willing to travel to participate in a specified activity.

20. A computer program product comprising a computer-readable medium having computer program logic recorded thereon for enabling a processor-based system to provide offers among groups of users based on compatibility between the groups and the offers, the computer program product comprising:
a first program logic module for enabling the processor-based system to determine a plurality of groups of users of a social networking system, each of the plurality of groups including a plurality of users, based on the plurality of users in each of the plurality of groups having at least one respective first attribute in common;
a second program logic module for enabling the processor-based system to, for each of the plurality of groups, determine a measure of compatibility between the plurality of users in the group and each of a plurality of offers by comparing at least one second attribute of each of the plurality of users in the group and at least one third attribute of the respective offer, each of the plurality of offers specifying a price of at least one commerce element; and
a third program logic module for enabling the processor-based system to, for each of the plurality of groups, present at least one selected offer selected from the plurality of offers to at least a subset of the plurality of users in the group in response to the at least one selected offer having a highest measure of compatibility among the plurality of offers.
